(19) United States
(12) Patent Application Publication
(10) Pub. No.: US 2012/0187853 A1
(43) Pub. Date: Jul. 26, 2012

(54) LED DRIVER

(75) Inventors: Sungeun Kim, Gwangsan-gu (KR); Taeyong Kim, Yongin-si (KR); Hyunkwan Lee, Gimje-se (KR); Shin Cho, Ansan-si (KR); Dongyoung Huh, Bucheon-si (KR)

(73) Assignee: LG INNOTEK CO., LTD., Seoul (KR)

(21) Appl. No.: 13/322,804

(22) PCT Filed: May 29, 2010
(86) PCT No.: PCT/KR2010/003437

§ 371 Date: Apr. 9, 2012

(30) Foreign Application Priority Data
May 29, 2009 (KR) 10-2009-0047596
May 29, 2009 (KR) 10-2009-0047616
Jun. 25, 2009 (KR) 10-2009-0057113

(51) Int. Cl. H05B 37/00

(52) U.S. Cl. 315/187

(57) ABSTRACT

An LED driver is comprising: at least two LED strings; a rectifier rectifying an alternating current (AC) voltage for supply to the LED strings; at least two balancing capacitors positioned at a current path of each LED string for carrying out a current balancing of the LED strings; at least two path control elements for controlling the current path of each LED string; and a controller controlling the path control elements.

### TECHNICAL FIELD

The present invention relates to an LED driver for supplying a driving power to LEDs.

### BACKGROUND ART

A LED light source device comprised of a plurality of LED (Light Emitting Diode) strings is rapidly propagated for a wider use in lighting devices and backlight assemblies for LCD panel.

Generally, an LED having a high brightness may be used for various application devices including backlight assemblies for LCD, monitors and televisions (hereinafter collectively referred to as “monitor”). The LEDs applied in a large-sized monitor are generally implemented in one or more strings connected in series.

In order to mount a backlight assembly to an LCD monitor, one of two basic technologies are employed. A first technology is to use one or more strings comprised of a white LED, where the white LED generally includes a blue LED having a fluorescent material. The fluorescent material absorbs the blue light generated by the LED to emit a white light. A second technology is to have one or more individual strings comprised of a colored LED in adjacent arrangement, whereby combined colors come to look white.

However, due to characteristic (e.g., forward voltage drop) deviation among LED elements comprising the LED strings, even LED strings comprising same types of LEDs show mutually different electrical features (e.g., voltage drop). Because of that, in order for the same current to flow through each LED string, there is a need to add a constant current control block connected in series to each LED string for compensating different voltage drops, which is applied with a dissipative active element for compensating the different voltage drops of the LED strings.

However, the dissipative active element suffers from disadvantages in that the dissipative active element, being a significant heat source, increases heat-radiating cost of an entire LED driver, and requires a large capacity of power supply device due to reduced power transmission efficiency.

### DISCLOSURE OF INVENTION

### Technical Problem

The present invention is disclosed to provide an LED driver capable of limiting a heating loss and capable of controlling an individual LED string. Furthermore, the present invention is disclosed to provide an LED driver capable of limiting a power waste. Still furthermore, the present invention is disclosed to provide an LED driver capable of providing a current balancing among LED strings by way of a simple structure.

### Solution to Problem

In one general aspect of the present invention, an LED driver is comprising: at least two LED strings; a rectifier rectifying an alternating current (AC) voltage for supply to the LED strings; at least two balancing capacitors positioned at a current path of each LED string for carrying out a current balancing of the LED strings; at least two path control elements for controlling the current path of each LED string; and a controller controlling the path control elements.

In another general aspect of the present invention, an LED driver is comprising: a transformer unit receiving an AC voltage through an input port; at least one or more first LED strings receiving a first-direction current from an output port of the transformer unit; at least one or more second LED strings receiving a second-direction current from an output port of the transformer unit; at least one or more first balancing capacitors disposed between the output port of the transformer unit and the first LED strings; at least one or more second balancing capacitors disposed between the output port of the transformer unit and the second LED strings; at least one or more first rectifying diodes for forming a single direction current path for rectification of the second LED strings and the first balancing capacitors; at least one or more second rectifying diodes for forming a single direction current path for rectification of the first LED strings and the second balancing capacitors; first path control elements for controlling a current path of each first LED string; and second path control elements for controlling a current path of each second LED string.

In still another general aspect of the present invention, an LED driver is comprising: a transformer unit receiving an AC voltage through an input port; at least one or more first LED strings receiving a first-direction current from an output port of the transformer unit; at least one or more second LED strings receiving a second-direction current from an output port of the transformer unit; at least one or more first balancing capacitors disposed between the output port of the transformer unit and the second LED strings; at least one or more second balancing capacitors disposed between the output port of the transformer unit and the first LED strings; at least one or more first rectifying diodes for forming a single direction current path for rectification of the first LED strings and the first balancing capacitors; at least one or more second rectifying diodes for forming a single direction current path for rectification of the second LED strings and the second balancing capacitors; first path control elements for controlling a current path of each first LED string; and second path control elements for controlling a current path of each second LED string.

### Advantageous Effects of Invention

The LED driver according to the present invention thus configured has an advantage in that it can restrict a heating loss and individually control the LED strings. Another advantage is that the LED driver can restrict a driving power loss. Still another advantage is that the LED driver can reduce the manufacturing cost. Still further advantage is that the LED driver can provide a current balancing between LED strings by way of a simple structure.

### BRIEF DESCRIPTION OF DRAWINGS

FIG. 1 is a circuit diagram illustrating a configuration of an LED driver smoothing a driving power of LED strings using a linear driving method.

FIG. 2 is a circuit diagram illustrating a configuration of an LED driver smoothing a driving power of LED strings using a switching method.

FIG. 3 is a block diagram illustrating a concept of an LED driver according to an exemplary embodiment of the present invention.

FIG. 4 is a circuit diagram illustrating an LED driver smoothing a driving power of LED strings using a dividing AC driving method according to an exemplary embodiment of the present invention.

FIG. 5 is a circuit diagram illustrating an LED driver smoothing a driving power of LED strings using a dividing AC driving method according to another exemplary embodiment of the present invention.

FIG. 6 is a circuit diagram illustrating an LED driver smoothing a driving power of LED strings using a dividing AC driving method according to still another exemplary embodiment of the present invention.

FIG. 7 is a circuit diagram illustrating an LED driver smoothing a driving power of LED strings using a dividing AC driving method according to still another exemplary embodiment of the present invention.

FIG. 8 is a circuit diagram illustrating an LED driver smoothing a driving power of LED strings using a dividing AC driving method according to still another exemplary embodiment of the present invention.

FIG. 9 is a circuit diagram illustrating an LED driver smoothing a driving power of LED strings using a dividing AC driving method according to still another exemplary embodiment of the present invention.

FIG. 10 is a circuit diagram illustrating an LED driver smoothing a driving power of LED strings using a dividing AC driving method according to still another exemplary embodiment of the present invention.

FIG. 11 is a circuit diagram illustrating an LED driver smoothing a driving power of LED strings using a dividing AC driving method according to still another exemplary embodiment of the present invention.

FIG. 12 is a circuit diagram illustrating an LED driver smoothing a driving power of LED strings using a dividing AC driving method according to still another exemplary embodiment of the present invention.

FIG. 13 is a block diagram illustrating a concept of an LED driver according to another exemplary embodiment of the present invention.

FIG. 14 is a circuit diagram illustrating an LED driver smoothing a driving power of LED strings using a dividing AC driving method according to still another exemplary embodiment of the present invention.

FIG. 15 is a circuit diagram illustrating an LED driver smoothing a driving power of LED strings using a dividing AC driving method according to still another exemplary embodiment of the present invention.

FIG. 16 is a circuit diagram illustrating an LED driver smoothing a driving power of LED strings using a dividing AC driving method according to still another exemplary embodiment of the present invention.

FIG. 17 is a circuit diagram illustrating an LED driver smoothing a driving power of LED strings using a dividing AC driving method according to still another exemplary embodiment of the present invention.

FIG. 18 is a circuit diagram illustrating an LED driver smoothing a driving power of LED strings using a dividing AC driving method according to still another exemplary embodiment of the present invention.

FIG. 19 is a circuit diagram illustrating an LED driver smoothing a driving power of LED strings using a dividing AC driving method according to still another exemplary embodiment of the present invention.

FIG. 20 is a circuit diagram illustrating an LED driver smoothing a driving power of LED strings using a dividing AC driving method according to still another exemplary embodiment of the present invention.

FIG. 21 is a circuit diagram illustrating an LED driver smoothing a driving power of LED strings using a dividing AC driving method according to still another exemplary embodiment of the present invention.

FIG. 22 is a circuit diagram illustrating an LED driver smoothing a driving power of LED strings using a dividing AC driving method according to still another exemplary embodiment of the present invention.

FIG. 23 is a circuit diagram illustrating an LED driver smoothing a driving power of LED strings using a dividing AC driving method according to still another exemplary embodiment of the present invention.

FIG. 24 is a circuit diagram illustrating an LED driver smoothing a driving power of LED strings using a dividing AC driving method according to still another exemplary embodiment of the present invention.

FIG. 25 is a circuit diagram illustrating an LED driver smoothing a driving power of LED strings using a dividing AC driving method according to still another exemplary embodiment of the present invention.

FIG. 26 is a block diagram illustrating a concept of an LED driver according to still another exemplary embodiment of the present invention.

FIG. 27 is a circuit diagram illustrating an LED driver smoothing a driving power of LED strings using a dividing AC driving method according to still another exemplary embodiment of the present invention.

FIG. 28 is a circuit diagram illustrating an LED driver smoothing a driving power of LED strings using a dividing AC driving method according to still another exemplary embodiment of the present invention.

FIG. 29 is a circuit diagram illustrating an LED driver smoothing a driving power of LED strings using a dividing AC driving method according to still another exemplary embodiment of the present invention.

FIG. 30 is a circuit diagram illustrating an LED driver smoothing a driving power of LED strings using a dividing AC driving method according to still another exemplary embodiment of the present invention.

### BEST MODE FOR CARRYING OUT THE INVENTION

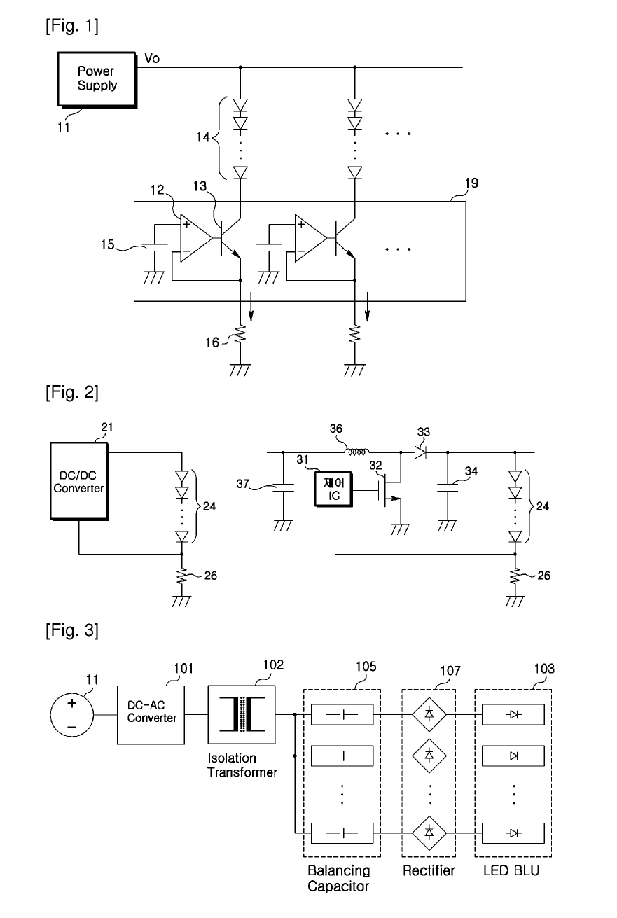

FIG. 1 is a circuit diagram illustrating a configuration of an LED driver smoothing a driving power of LED strings using a linear driving method.

Referring to FIG. 1, each LED string receives a driving power from a common power supply (11), and a current path formed by each LED string is connected by fixed current sources (19) comprising bipolar transistors (13) and operational (OP) amplifiers (12). The same current is supplied to each LED string by the fixed current sources (19) in the illustrated circuit, such that even if there exist some characteristic deviations in the LED strings, the brightness of each LED string can be equally maintained.

The LED driver according to the method thus described may have advantages in which an accurate current control is enabled to easily implement additional functions such as dimming and the like but have disadvantages in that the LED strings having mutually different forward voltage drop values are arbitrarily forced to cause the same size of current, to flow, whereby a heating loss caused by a resistance element (16) on the current path is generated.

FIG. 2 is a circuit diagram illustrating a configuration of an LED driver smoothing a driving power of LED strings using a switching method.

Each LED string (24) in the illustrated LED driver is disposed with DC-DC switching converters (21). As shown in FIG. 2, a switching control IC (31) that has detected an output current of each LED string ‘time-division’ controls a switching transistor (32) of each DC-DC switching converter (21) to adjust an average current flowing in each relevant LED string (24).

The LED driver according to FIG. 2 has an advantage in that a heating loss caused by the resistance element can be limited but has a disadvantage in that an accurate current control process is complicated to increase the manufacturing cost and there is a difficulty in implementing additional functions.

### First Exemplary Embodiment

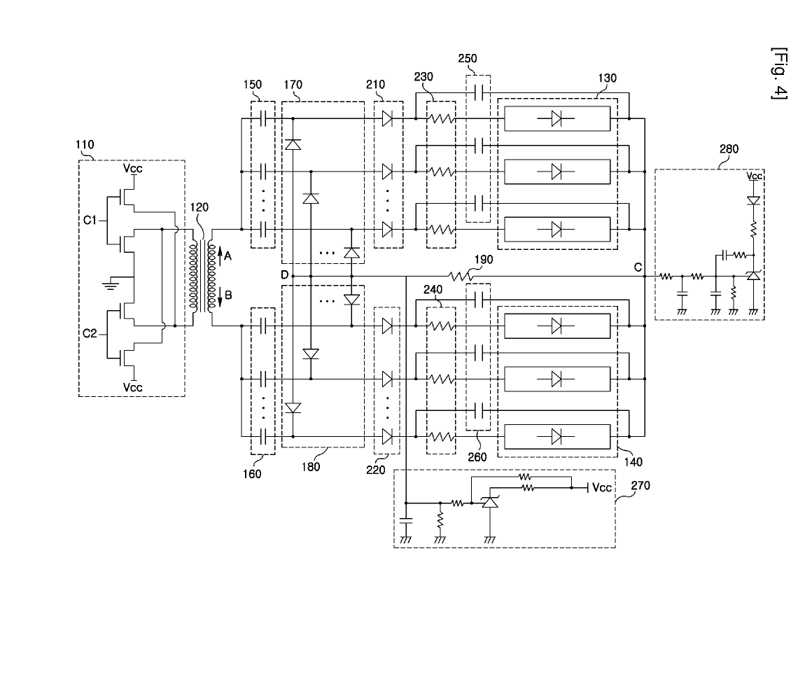

FIG. 3 is a block diagram illustrating a concept of an LED driver according to an exemplary embodiment of the present invention.

An LED driver according to FIG. 3 may include at least two LED strings (103), a rectifier (107) rectifying an AC voltage and supplying the rectified AC voltage to the LED strings, and at least two current balancing capacitors (105) disposed on a current path of each LED string for carrying out a current balancing of the LED strings. The LED driver at a power supply side may further include a DC-DC converter (101) converting a DC voltage to an AC voltage along with a DC voltage power supply (11), and a transformer unit (102) transmitting the converted AC voltage to the rectifier (107).

FIG. 4 is a circuit diagram illustrating an LED driver smoothing a driving power of LED strings using a dividing AC driving method according to an exemplary embodiment of the present invention.

A DC-AC converter (110) of FIG. 4 may be functionally a counterpart to the DC-AC converter (11) of FIG. 3, and first/second rectifying diodes (170, 180) and first/second sub-rectifying diodes (210, 220) {or first/second LED strings (130, 140)} of FIG. 4 may be functionally counterparts to the rectifier (107) of FIG. 3. First/second balancing capacitors (150, 160) of FIG. 4 may be functionally counterparts to the current balancing capacitor (105) of FIG. 3, while first/second LED strings (130, 140) of FIG. 4 may be counterparts to the LED strings (103) of FIG. 3.

The LED driver in FIG. 4 may include a DC-AC converter (110) as an AC power supply applying an AC voltage to the LED driver, a transformer unit (120) receiving the AC voltage of the DC-AC converter (110) through an input port, at least one or more first LED strings (130) receiving a first-direction (A) current from an output port of the transformer unit (120), at least one or more second LED strings (140) receiving a second-direction (B) current from an output port of the transformer unit (120), at least one or more first balancing capacitors (150) disposed between the output port of the transformer (120) and the first LED strings (130), at least one or more second balancing capacitors (160) disposed between the output port of the transformer (120) and the second LED strings (140), at least one or more first rectifying diodes (170) for sending a current via the second LED strings (140) to the transformer (120) through the first balancing capacitors (150), and at least one or more second rectifying diodes (180) for sending a current via the first LED strings (130) to the transformer (120) through the second balancing capacitors (160).

The first LED strings (130) are so disposed as to allow the current to flow from the first balancing capacitors (150) to the first LED strings (130), and the second LED strings (140) are so disposed as to allow the current to flow from the second balancing capacitors (160) to the second LED strings (140). As a result, the first/second rectifying diodes (170, 180) and the first/second LED strings (130, 140) may form a rectifying circuit due to reverse direction current limiting function of the first/second LED strings (130, 140), which is caused by the fact that the first/second LED strings (130, 140) basically have diode characteristics.

However, in order to arrange first/second ripple removing capacitors (250, 260), or to prevent the LEDs from being damaged by instantly flowing high voltage reverse current, at least one or more sub-rectifying diodes (210) connected in the same direction as that of the first LED strings (130) may be disposed between the first LED strings (130) and the first balancing capacitors (150), and at least one or more second sub-rectifying diodes (220) connected in the same direction as that of the second LED strings (140) may be disposed between the second balancing capacitors (160) and the second LED strings (140).

Furthermore, in order to protect the first/second LED strings (130, 140), at least one or more first resistors (230) connected between the first sub-rectifying diodes (210) and the first LED strings (130), and at least one or more second resistors (240) connected between the second sub-rectifying diodes (220) and the second LED strings (140) may be additionally disposed.

Furthermore, in order to bypass the ripple components in the current introduced via the transformer (120) and the first/second balancing capacitors (150, 160), at least one or more first ripple removing capacitors (250) connected in parallel with the first LED strings (130), and at least one or more second ripple removing capacitors (260) connected in parallel with the second LED strings (140) may be arranged.

As illustrated in FIG. 4, cathodes of the first rectifying diodes (210) are connected to the first balancing capacitors (150), and cathodes of the second rectifying diodes (220) are connected to the second balancing capacitors (160), while cathodes of the first/second rectifying diodes (210, 220) are commonly connected.

One end of cathode sides in the first/second LED strings (130, 140) is commonly connected, and the current at a common node at the cathode sides of the first/second LED strings (130, 140) flows to a common node at anode sides of the first/second rectifying diodes (170, 180). A measurement resistor (190) may be arranged between a common node (C) of cathode sides of the first/second LED strings (130, 140) and a common node (D) of anode sides of the first/second rectifying diodes (170, 180).

Although the measurement resistor (190) fails to drive the LEDs in the LED driver, the resistor is used for easily detecting an entire current in the LED driver. That is, a current flowing in the measurement resistor (190) may be measured from a voltage that is applied across the measurement resistor (190). This is because it is a burden costwise and sizewise to mount an element that measures a voltage but it is not a burden costwise and sizewise to mount an element that measures a current.

The DC-AC converter (110) may convert a DC voltage to an AC voltage by using four switching transistors to change the direction of DC current applied to a coil at an input side of the transformer (120).

Although it is not shown in FIG. 4, the LED driver may include a controller generating control signals (C1, C2) controlling the four switching transistors of the DC-AC converter (110). The controller may use the control signals (C1, C2) for feedback control of constant current flow by receiving a current flowing in the measurement resistor (190). The illustrated LED driver may further include a first offset applier (280) providing an offset voltage to the C node, and a second offset applier (270) providing an offset voltage to the D node.

Now, operation of the illustrated LED driver will be described.

An AC pattern (i.e., sine wave) current flows in a coil at an output terminal side of the transformer, where the AC current is applied to the first/second LED strings via the first/second balancing capacitors.

In a case a current in the A direction flows in the output terminal side of the transformer according to a plus direction pattern in the sine wave, the A direction current passes through the first LED strings (130) and the first sub-rectifying diodes (210) applied with a forward bias, the current cannot pass the second LED strings (140) and the second sub-rectifying diodes (220) where a reverse bias is applied.

The current having passed the first LED strings (130) is converged at the C node to be discharged via the measurement resistor (190). However, due to voltage drop by the current-flowing first LED strings (130) and the first sub-rectifying diodes (210), a current path at the first rectifying diodes (170) is blocked by the reverse bias, but a current path at the second rectifying diodes (180) is opened due to forward bias by the electromotive force at a coil of the output terminal side of the transformer for causing the current to flow in the A direction. As a result, the current introduced into the D node passes the second balancing capacitors (160) to be circulated to the transformer (120).

Resultantly, the first LED strings (130) are driven in a section where the current flows in the A direction, while the second LED strings (140) are not driven. In the likewise process, the second LED strings (140) are driven in a section where the current flows in the B direction, while the first LED strings (130) are not driven.

That is, the first rectifying diode (170) and the first sub-rectifying diode (210) or the first LED strings (130) form a kind of half-wave rectifying circuit. Furthermore, the second rectifying diode (180) and the first sub-rectifying diode (220) or the first LED strings (140) form a kind of half-wave rectifying circuit. Although both cases form a half-wave rectifying circuit, the first LED rectifying diode (170) is driven in the A direction current section, while the second LED rectifying diode (180) is driven in the B direction current section, such that there is generated no power loss as experienced by the conventional half-wave rectifying circuit.

In the illustrated LED driver, in a case there exists a deviation in the forward direction voltage drop due to characteristic deviation of each first LED string, each first balancing capacitor (150) is only accumulated with mutually different charges by the deviation in the A direction current section. The charges of different quantity accumulated in the each first balancing capacitor (150) is removed in the B direction current section. After all, even if there is a deviation in the forward voltage drop in each first LED string (130), there is generated no current deviation (or brightness deviation resultant therefrom) in the first LED string (130) of the illustrated LED driver. In the likewise theory, even if there is a deviation in the forward voltage drop in each second LED string (140), there is generated no current deviation (or brightness deviation resultant therefrom) in the second LED string (140).

Now, with regard to the A direction current path and the B direction current path, there are no resistance elements on the two current paths except for a first resistor (230) and a second resistor (240). Therefore, it is appreciated that the illustrated LED driver can greatly restrict the heating loss that is caused by the resistance elements.

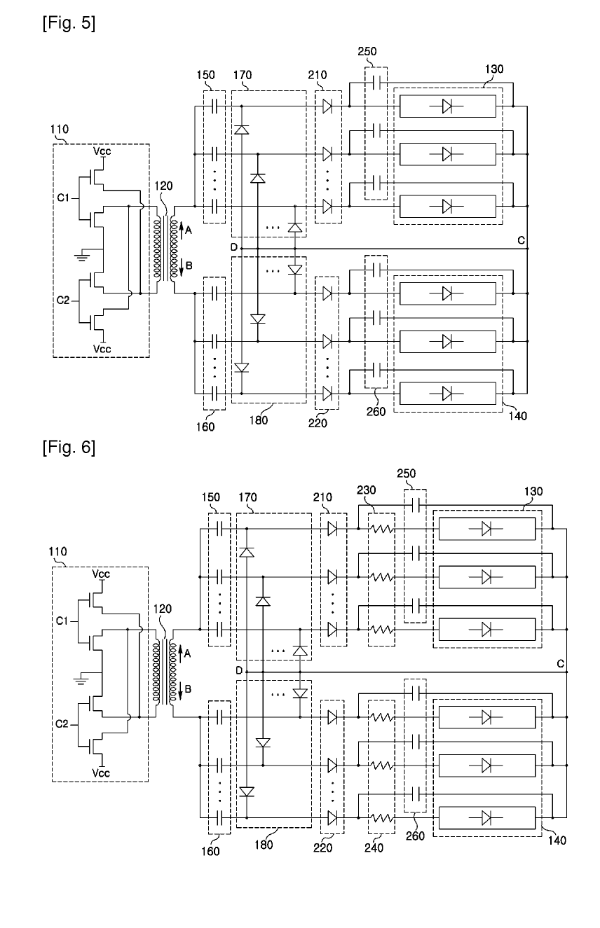

FIGS. 5 to 7 illustrate an LED driver in a simpler configuration than that of FIG. 4 according to another exemplary embodiments of the present invention.

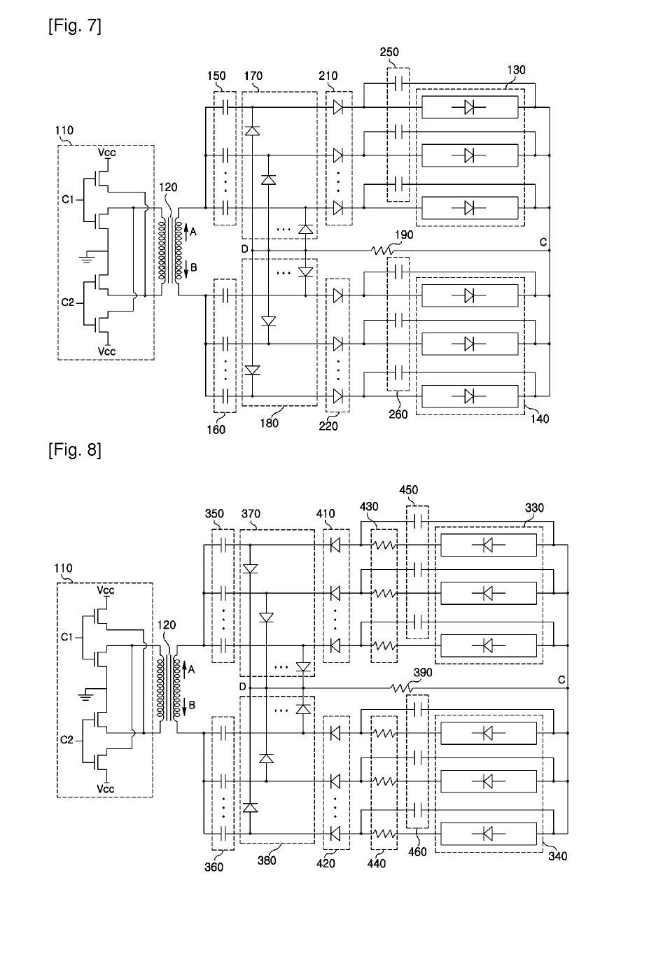

FIG. 5 illustrates an LED driver having no resistance on a driving path, FIG. 6 illustrates an LED driver having only a first resistor (230) and a second resistor (240) on the driving path, and FIG. 7 illustrates an LED diver mounted only with a measurement resistor (190) for easily detecting an entire current of the LED driver. Each configuration and operation in FIGS. 5 to 7 can be easily derived from that of FIG. 4, such that any overlapping explanation will be deleted.

FIG. 8 is a circuit diagram illustrating an LED driver smoothing a driving power of LED strings using a dividing AC driving method according to still another exemplary embodiment of the present invention.

The LED driver in FIG. 8 may include a DC-AC converter (310) as an AC power supply applying an AC voltage to the LED driver, a transformer unit (320) receiving the AC voltage from the DC-AC converter (310) through an input port, at least one or more first LED strings (330) receiving a first-direction (A) current from an output port of the transformer unit (320), at least one or more second LED strings (340) receiving a second-direction (B) current from an output port of the transformer unit (320), at least one or more first balancing capacitors (350) coupling the output port of the transformer unit (320) and the first LED strings (330), at least one or more second balancing capacitors (360) coupling the output port of the transformer unit (320) and the second LED strings (340), at least one or more first rectifying diodes (370) for sending a current supplied from the transformer unit (320) via the first balancing capacitors (350) to the second LED strings (340), and at least one or more second rectifying diodes (380) for sending a current supplied from the transformer unit (320) via the second balancing capacitors (360) to the first LED strings (330).

Now, the first LED strings (330) are so disposed as to allow the current to flow from the first LED strings (330) to the first balancing capacitors (350), and the second LED strings (340) are so disposed as to allow the current to flow from the second LED strings (340) to the second balancing capacitors (360).

Furthermore, in order to prevent the LED from being damaged by an instant high voltage reverse current, at least one or more first sub-rectifying diodes (410) connected in the same direction as that of the first LED strings (330) between the first balancing capacitors (350) and the first LED strings (330) may be arranged, and at least one or more second rectifying diodes (420) connected in the same direction as that of the second LED strings (340) between the second balancing capacitors (360) and the second LED strings (340) may be arranged.

Furthermore, in order to protect the first/second LED strings (330, 340), at least one or more first resistors (430) connected between the first sub-rectifying diodes (410) and the first LED strings (430), and at least one or more second resistors (440) connected between the second sub-rectifying diodes (420) and the second LED strings (340) may be additionally disposed.

Still furthermore, at least one or more first ripple removing capacitors (450) connected in parallel with the first LED strings (330), and at least one or more second ripple removing capacitors (460) connected in parallel with the second LED strings (340) may be arranged.

Still furthermore, a measurement resistor (390) may be arranged between a common node (C) of anode sides of the first/second LED strings (330,340) and a common node (D) of cathode sides of the first/second rectifying diodes (370, 380). Although not shown in FIG. 8, the LED driver may include a controller generating control signals (C1, C2) for controlling four switching transistors. The controller may use the control signals (C1, C2) for feedback control of constant current flow by receiving a current flowing in the measurement resistor (390). The description of operation and principle of the illustrated LED driver can be easily derived from the explanation of FIG. 4, such that any overlapping description will be omitted.

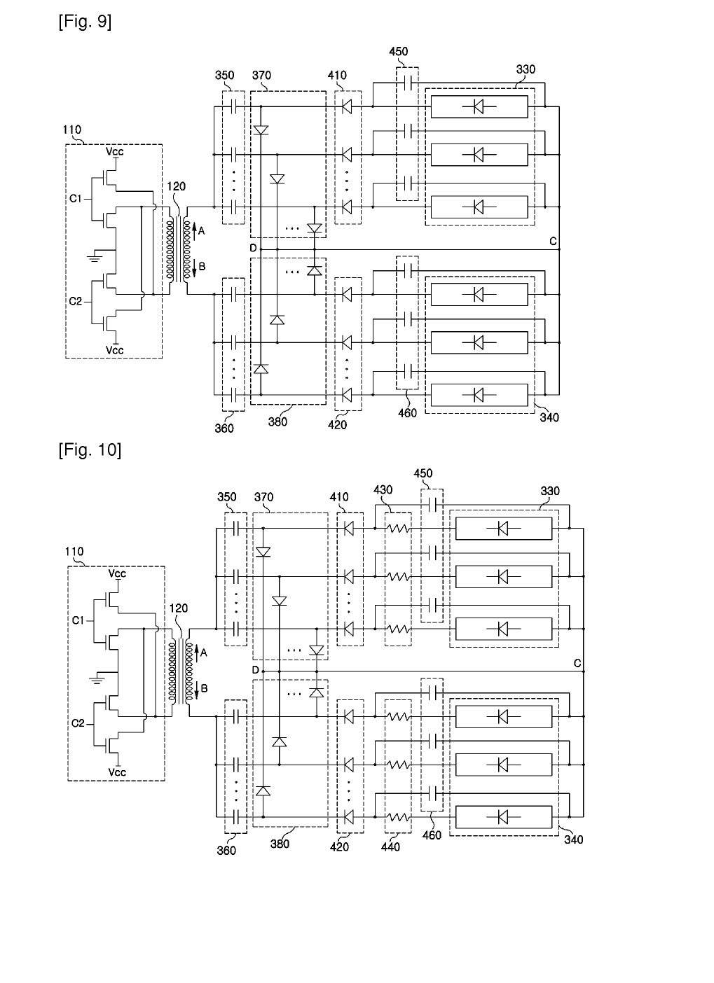

FIGS. 9 to 11 illustrate an LED driver in a simpler configuration than that of FIG. 8 according to still another exemplary embodiments of the present invention.

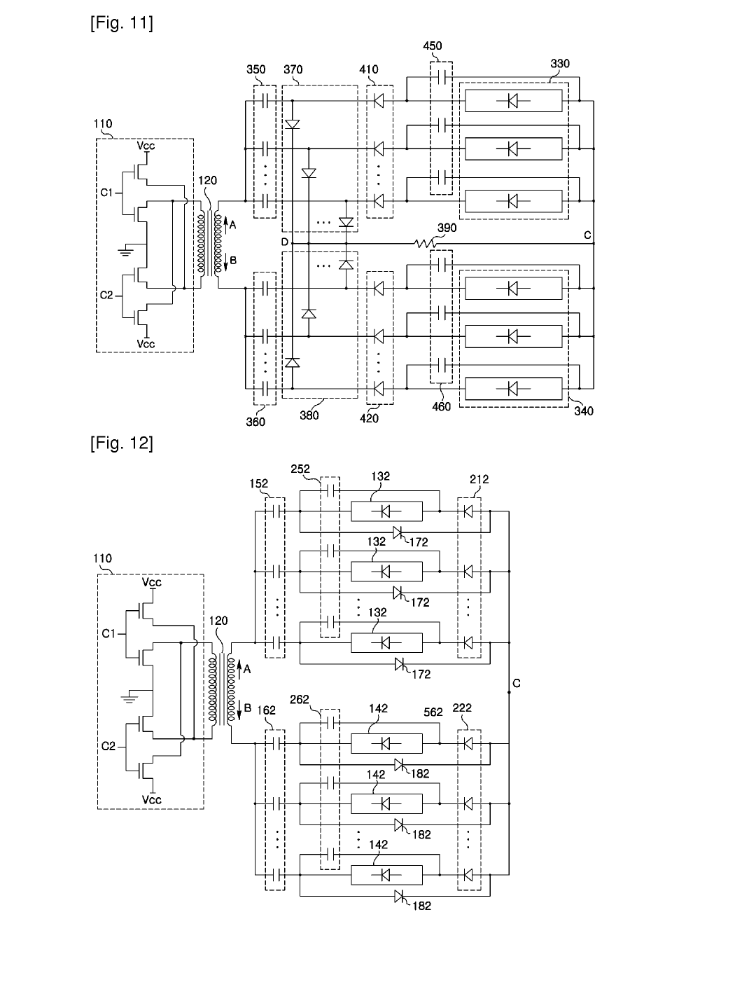

FIG. 9 illustrates an LED driver having no resistance on a driving path, FIG. 10 illustrates an LED driver having only a first resistor (430) and a second resistor (440) on the driving path, and FIG. 11 illustrates an LED diver mounted only with a measurement resistor (390) for easily detecting an entire current of the LED driver. Each configuration and operation of each LED driver shown in FIGS. 9 to 11 can be easily derived from that of FIGS. 4 and 5, such that any overlapping explanation will be deleted.

FIG. 12 is a circuit diagram illustrating an LED driver having no ground line according to still another exemplary embodiment of the present invention. That is, FIG. 12 is a circuit diagram illustrating an LED driver smoothing a driving power of LED strings using a dividing AC driving method according to still another exemplary embodiment of the present invention.

A DC-AC converter (110) of FIG. 12 may be functionally a counterpart to the DC-AC converter (11) of FIG. 3, and first/second rectifying diodes (172, 182) and first/second sub-rectifying diodes (212, 222) {or first/second LED strings (132, 142)} of FIG. 10 may be functionally counterparts to the rectifier (107) of FIG. 3. First/second balancing capacitors (152, 162) of FIG. 12 may be functionally counterparts to the current balancing capacitor (105) of FIG. 3, while first/second LED strings (132, 142) of FIG. 10 may be counterparts to the LED strings (103) of FIG. 3. A bipolar transistor (512) of FIG. 12 serves to function the path control element (108) of FIG. 3.

The LED driver of FIG. 12 may include a DC-AC converter (110) as an AC power supply applying an AC voltage to the LED driver, a transformer unit (120) receiving the AC voltage from the DC-AC converter (310) through an input port, at least one or more first LED strings (142) receiving a first-direction (A) current from an output port of the transformer unit (120), at least one or more second LED strings (132) receiving a second-direction (B) current from an output port of the transformer unit (120), at least one or more first balancing capacitors (152) disposed between the output port of the transformer unit (120) and the second LED strings (132), at least one or more second balancing capacitors (162) disposed between the output port of the transformer unit (120) and the first LED strings (142), at least one or more first rectifying diodes (172) for forming a rectifying single direction current path via the first balancing capacitors (152) to the first LED strings (142), and at least one or more second rectifying diodes (182) for forming a rectifying single direction current path via the second balancing capacitors (162) to the second LED strings (132).

The first/second rectifying diodes (172, 182) and the first/second LED strings (132, 142) may form a rectifying circuit due to reverse direction current limiting function of the first/second LED strings (132, 142), which is caused by the fact that the first/second LED strings (132, 142) basically have diode characteristics.

However, in order to arrange first/second ripple removing capacitors (252, 262), or to prevent the LEDs from being damaged by instantly flowing high voltage reverse current, at least one or more sub-rectifying diodes (222) connected in the same direction as that of the first LED strings (142) may be disposed between a second bipolar transistor (522) and the first LED strings (142), and at least one or more second sub-rectifying diodes (212) connected in the same direction as that of the second LED strings (132) may be disposed between a first bipolar transistor (512) and the second LED strings (132).

Furthermore, in order to restrict ripple components in the current introduced via the transformer (120) and the first/second balancing capacitors (152, 162), at least one or more first ripple removing capacitors (262) connected in parallel with the first LED strings (142), and at least one or more second ripple removing capacitors (252) connected in parallel with the second LED strings (132) may be arranged. Still furthermore, a current measuring device may be disposed at an output port of the transformer unit (120) or a common node of the first balancing capacitor. The current measuring device may be a current measuring transformer.

### Second Exemplary Embodiment

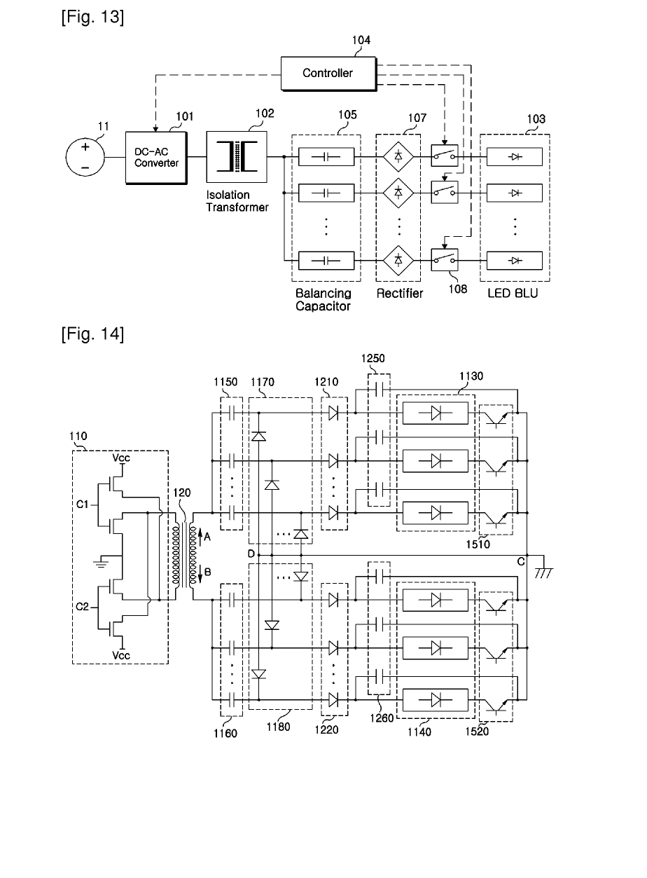

FIG. 13 is a block diagram illustrating a concept of an LED driver according to another exemplary embodiment of the present invention.

The LED driver according to FIG. 13 may include at least two LED strings (103), a rectifier (107) rectifying an alternating current (AC) voltage for supply to the LED strings, at least two balancing capacitors (105) positioned on a current path of each LED string for carrying out a current balancing of the LED strings, a path control element (108) for individually controlling the current supply of each LED string, and a controller (104) controlling the path control element (108), and may further include at a power supply side a DC-AC converter (101) converting the DC voltage to AC voltage along with a DC power supply (11), and a transformer unit (102) transmitting the converted AC voltage to the rectifier (107).

FIG. 14 is a circuit diagram illustrating an LED driver smoothing a driving power of LED strings using a dividing AC driving method according to still another exemplary embodiment of the present invention.

A DC-AC converter (110) of FIG. 14 may be functionally a counterpart to the DC-AC converter (11) of FIG. 3, and first/second rectifying diodes (1170, 1180) and first/second sub-rectifying diodes (1210, 122) {or first/second LED strings (1130, 1140)} of FIG. 14 may be functionally counterparts to the rectifier (107) of FIG. 3. First/second balancing capacitors (1150, 1160) of FIG. 14 may be functionally counterparts to the current balancing capacitor (105) of FIG. 3, while first/second LED strings (1130, 1140) of FIG. 14 may be counterparts to the LED strings (103) of FIG. 3. A bipolar transistor (1510) of FIG. 14 serves to function the path control element (108) of FIG. 3.

The LED driver in FIG. 14 may include a DC-AC converter (110) as an AC power supply applying an AC voltage to the LED driver, a transformer unit (120) receiving the AC voltage from the DC-AC converter (110) through an input port, at least one or more first LED strings (1130) receiving a first-direction (A) current from an output port of the transformer unit (120), at least one or more second LED strings (1140) receiving a second-direction (B) current from an output port of the transformer unit (120), at least one or more first balancing capacitors (1150) disposed between the output port of the transformer unit (120) and the first LED strings (1130), at least one or more second balancing capacitors (1160) disposed between the output port of the transformer unit (120) and the second LED strings (1140), at least one or more first rectifying diodes (1170) for sending a current via the second LED strings (1140) to the transformer unit (120) via the first balancing capacitors (1150), and at least one or more second rectifying diodes (1180) for sending a current via the first LED strings (1130) to the transformer unit (120) via the second balancing capacitors (1160), at least two first bipolar transistors (1510) adjusting a current path of the each first LED string (1130), and at least two second bipolar transistors (1520) adjusting a current path of the each second LED string (1140).

Now, the first LED strings (1130) are so disposed as to allow the current to flow from the first balancing capacitors (1150) to the first LED strings (1130), and the second LED strings (1140) are so disposed as to allow the current to flow from the second balancing capacitors (1160) to the second LED strings (1140). As a result, the first/second rectifying diodes (1170, 1180) and the first/second LED strings (1130, 1140) may form a rectifying circuit due to reverse direction current limiting function of the first/second LED strings (1130, 1140), which is caused by the fact that the first/second LED strings (1130, 1140) basically have characteristics as diodes.

However, in order to arrange first/second ripple removing capacitors (1250, 1260), or to prevent the LEDs from being damaged by an instant high voltage reverse current, at least one or more first sub-rectifying diodes (1210) connected in the same direction as that of the first LED strings (1130) between the first balancing capacitors (1150) and the first LED strings (1130) may be arranged, and at least one or more second rectifying diodes (1220) connected in the same direction as that of the second LED strings (1140) between the second balancing capacitors (1160) and the second LED strings (1140) may be arranged.

Still furthermore, in order to bypass ripple components in the current introduced via the transformer unit (120) and the first/second balancing capacitors (1150,1160), at least one or more first ripple removing capacitors (1250) connected in parallel with the first LED strings (1130), and at least one or more second ripple removing capacitors (1260) connected in parallel with the second LED strings (1140) may be arranged.

As illustrated, anodes of the first rectifying diodes (1210) are connected to the first balancing diodes (1150), and anodes of the second rectifying diodes (1220) are connected to the second balancing diodes (1160).

A cathode of the first rectifying diode (1210) is connected to a collector terminal of the first bipolar transistors (1510), and a cathode of the second rectifying diode (1220) is connected to a collector terminal of the second bipolar transistors (1510, 1520). Emitters of the first/second bipolar transistors (1510, 1520) are commonly connected.

A current collected at a common node (C) at the emitter side of the first/second bipolar transistors (1510, 1520) flows to a common node (D) at the anode side of the first/second rectifying diodes (1170, 1180). The first bipolar transistors (1510) are so connected as to allow collector-emitter to be arranged in the forward direction of the first LED strings (1130) forming the same current path, and the second bipolar transistors (1520) are so connected as to allow collector-emitter to be arranged in the forward direction of the second LED strings (1140) forming the same current path. The common connection node (C) of emitters of the first/second bipolar transistors (1510, 1520) may be grounded.

Furthermore, although it is not shown in the figure, the LED driver may include a controller individually adjusting each base terminal current of the first/second bipolar transistors (1510, 1520). The controller may apply an ON/OFF current to each base terminal so that each of the first/second bipolar transistors (1510, 1520) can operate as a switch. Alternatively, the controller may apply a current having a linear value to each base terminal so that each of the first/second bipolar transistors (1510, 1520) can linearly adjust a width of the current path.

Furthermore, a measurement resistor (not shown) may be arranged between a common connection node (C) of emitters of the first/second bipolar transistors (1510, 1520) and a common connection node (D) at anode side of the first/second rectifying diodes (1170, 1180). Although the measurement resistor fails to carry out the function of driving the LEDs in the LED driver, but may be used to easily detect an entire current of the LED driver. That is, a current flowing in the measurement resistor may be calculated from a voltage that is applied across the measurement resistor. This is because it may be a burden costwise and sizewise to mount an element that calculates a current but it may not be a burden costwise and sizewise to mount an element that measures a voltage.

The DC-AC converter (110) may convert a DC voltage to an AC voltage by using four switching transistors to change the direction of DC current applied to a coil at an input side of the transformer unit (120).

Meanwhile, the controller controlling the first/second bipolar transistors (1510, 1520) may apply control signals (C1, C2) to the four switching transistors controlling the four switching transistors of the DC-AC converter (110). The controller may use the control signals (C1, C2) for feedback control of constant current flow by receiving a current flowing in the measurement resistor. The illustrated LED driver may further include a first offset applier providing an offset voltage to the C node, and a second offset applier providing an offset voltage to the D node.

Now, operation of the illustrated LED driver will be described.

An AC pattern (e.g., sine wave) current flows in a coil at the output terminal side of the transformer unit, and the AC current passes the first/second balancing capacitors to be applied to the first/second LED strings.

In a case an A direction current flows in the output terminal side of the transformer according to a plus direction pattern in the sine wave, although the A direction current passes through the first LED strings (1130) and the first sub-rectifying diodes (1210) applied with a forward bias, the current cannot pass the second LED strings (1140) and the second sub-rectifying diodes (1220) where a reverse bias is applied.

The current having passed the first LED strings (1130) is converged at the C node to be discharged via a measurement resistor (1190). However, due to voltage drop by the current-flowing first LED strings (1130) and the first sub-rectifying diodes (1210), a current path at the first rectifying diodes (1170) is blocked by the reverse bias, but a current path at the second rectifying diodes (1180) is opened due to forward bias by the electromotive force at a coil of the output terminal side of the transformer unit for causing the current to flow in the A direction. As a result, the current introduced into the D node passes the second balancing capacitors (1160) to be circulated to the transformer unit (120).

Resultantly, the first LED strings (1130) are driven in a section where the current flows in the A direction, while the second LED strings (1140) are not driven. In the likewise process, the second LED strings (1140) are driven in a section where the current flows in the B direction, while the first LED strings (1130) are not driven.

That is, the first rectifying diode (1170) and the first sub-rectifying diode (1210) or the first LED strings (1130) form a kind of half-wave rectifying circuit. Furthermore, the second rectifying diode (1180) and the first sub-rectifying diode (1220) or the first LED strings (1140) form a kind of half-wave rectifying circuit. Although both cases form a half-wave rectifying circuit, the first LED strings (1130) are driven in a section where a current flows in the A direction, while the second LED strings (1180) are driven in a section where a current flows in the B direction, such that there is generated no power loss as experienced by the conventional half-wave rectifying circuit.

In the illustrated LED driver, in a case there exists a deviation in the forward direction voltage drop due to characteristic deviation of each first LED string, each first balancing capacitor (1150) is only accumulated with mutually different charges by the deviation in the section where a current flow is in A direction. The charges of different quantity accumulated in the each first balancing capacitor (1150) are removed in the section where a current flows in the B direction. After all, even if there is a deviation in the forward voltage drop in each first LED string (1130), there is generated no current deviation (or brightness deviation resultant therefrom) in the first LED string (1130) of the illustrated LED driver. In the likewise theory, even if there is a deviation in the forward voltage drop in each second LED string (1140), there is generated no current deviation (or brightness deviation resultant therefrom) in the second LED string (1140).

Now, with regard to the A direction current path and the B direction current path, there are no resistance elements on the two current paths. Therefore, it is appreciated that the illustrated LED driver can greatly restrict the heating loss that is caused by the resistance elements.

Meanwhile, an appropriate adjustment of base current at the first bipolar transistor (1510) or the second bipolar transistor (1520) can individually adjust the brightness of the first LED strings (1130) or the second LED strings (1140). For example, an current turning on and turning off the first/second bipolar transistors (1510, 1520) may be applied to the base to individually adjust the brightness by way of PWM (Pulse Width Modulation) method.

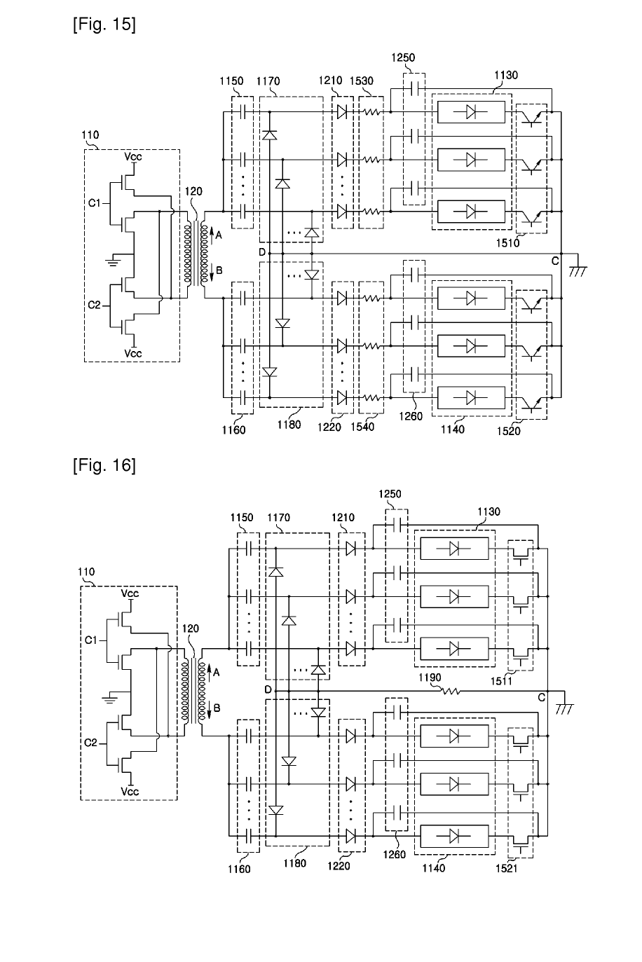

An LED driver of FIG. 15 may further include first stabilizing resistors (1530) connected between a connection node between first LED strings (1130) and first ripple removing capacitor (1250) and first sub-rectifying diodes (1210), and second stabilizing resistors (1540) connected between a connection node between the second LED strings (1140) and the second ripple removing capacitor (1260) and the second sub-rectifying diodes (1220), the configuration of which differs that of the LED driver in FIG. 4.

Switching by using the first bipolar transistors (1510) and the second bipolar transistors (1520) whose emitter terminals are grounded may decrease the grounding characteristic, where the first/second stabilizing resistors (1530, 1540) may prevent the grounding characteristic from being deteriorated. Other constituent elements in FIG. 15 are the same as those of FIG. 4 except for the first/second stabilizing resistors, such that overlapping explanation is omitted.

An LED driver of FIG. 16 is applied with first MOS (metal oxide semiconductor) transistors (1511) replacing the first bipolar transistors (1510) of FIG. 14 and with second MOS transistors (1521) replacing the second bipolar transistors (1520) of FIG. 14. The LED driver of FIG. 16 is also disposed with a measurement resistor (1190) not shown in FIG. 14.

The MOS transistor is different from the bipolar transistor in that the MOS transistor cannot linearly control a current path but is capable of conducting an ON/OFF control. The MOS transistor is also different from the bipolar transistor in that the MOS transistor is controlled by voltage, not by current. However, the ON/OFF operation is the same for both transistors, each as a kind of switch, such that there will be no further overlapping description thereto. Remaining constituent elements of FIG. 16 except for the first/second MOS transistors (1511, 1521) and the measurement resistor (1190) are the same as those of FIG. 14, such that no overlapping explanation will be given.

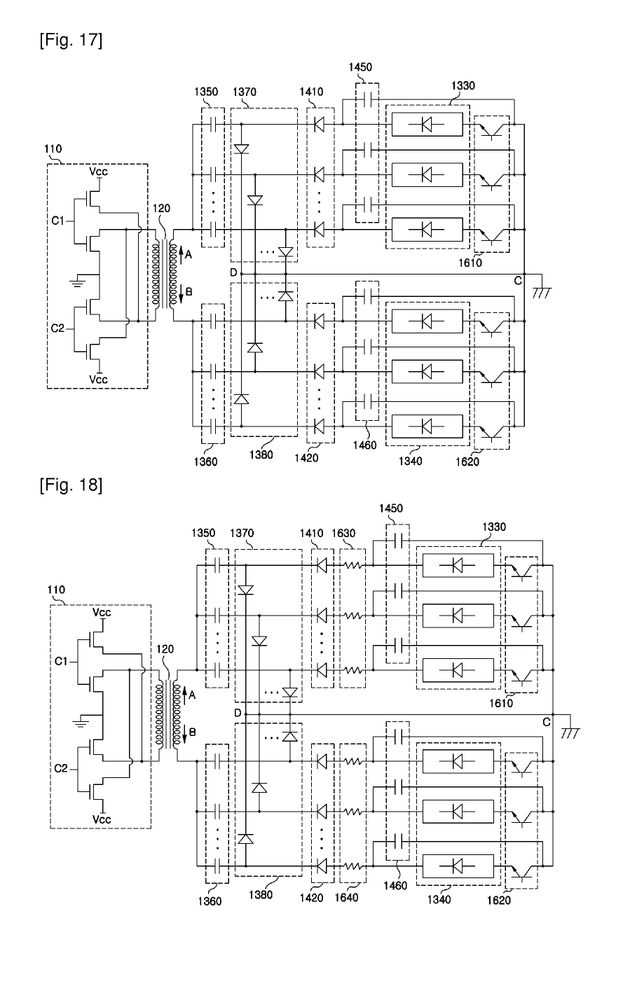

FIG. 17 is a circuit diagram illustrating an LED driver smoothing a driving power of LED strings using a dividing AC driving method according to still another exemplary embodiment of the present invention.

The LED driver in FIG. 17 may include a DC-AC converter (110) as an AC power supply applying an AC voltage to the LED driver, a transformer unit (120) receiving the AC voltage from the DC-AC converter (110) through an input port, at least one or more first LED strings (1330) receiving a first-direction (B) current from an output port of the transformer unit (120), at least one or more second LED strings (1340) receiving a second-direction (A current from an output port of the transformer unit (120), at least one or more first balancing capacitors (1350) coupling the output port of the transformer unit (120) and the first LED strings (1330), at least one or more second balancing capacitors (1360) coupling the output port of the transformer unit (120) and the second LED strings (1340), at least one or more first rectifying diodes (1370) for sending a current supplied from the transformer unit (120) via the first balancing capacitors (1350) to the second LED strings (1340), at least one or more second rectifying diodes (1380) for sending a current supplied from the transformer unit (120) via the second balancing capacitors (1360) to the first LED strings (1330), at least two first bipolar transistors (1610) adjusting a current path of the each first LED string (1130), and at least two second bipolar transistors (1620) adjusting a current path of the each second LED string (1140).

Now, the first LED strings (1330) are so disposed as to allow the current to flow from the first LED strings (1330) to the first balancing capacitors (1350), and the second LED strings (1340) are so disposed as to allow the current to flow from the second LED strings (1340) to the second balancing capacitors (1360).

Furthermore, in order to prevent the LED from being damaged by an instant reverse high voltage current, at least one or more first sub-rectifying diodes (1410) connected in the same direction as that of the first LED strings (1330) between the first balancing capacitors (1350) and the first LED strings (1330) may be arranged, and at least one or more second rectifying diodes (1420) connected in the same direction as that of the second LED strings (1340) between the second balancing capacitors (1360) and the second LED strings (1340) may be arranged.

Still furthermore, at least one or more first ripple removing capacitors (1450) connected in parallel with the first LED strings (1330), and at least one or more second ripple removing capacitors (1460) connected in parallel with the second LED strings (1340) may be arranged.

As illustrated, cathodes of the first rectifying diodes (1410) are connected to the first balancing diodes (1350), and cathodes of the second rectifying diodes (1420) are connected to the second balancing diodes (1360).

Anodes of the first LED strings (1330) are connected to an emitter terminal of the first bipolar transistor (1610), and anodes of the second LED strings (1340) are connected to an emitter terminal of the second bipolar transistor (1620). Collectors of the first/second bipolar transistors (1610, 1620) are commonly connected.

A current collected at a common node (C) at the collector side of the first/second bipolar transistors (1610, 1620) flows to a common node (D) at the cathode side of the first/second rectifying diodes (1370, 1380). The first bipolar transistors (1610) are so connected as to allow collector-emitter to be arranged in the forward direction of the first LED strings (1330) forming the same current path, and the second bipolar transistors (1620) are so connected as to allow collector-emitter to be arranged in the forward direction of the second LED strings (1340) forming the same current path. The common connection node (C) of collectors of the first/second bipolar transistors (1610, 1620) may be grounded.

Furthermore, although it is not shown in the figure, the LED driver may include a controller individually adjusting each base terminal current of the first/second bipolar transistors (1610, 1620). The controller may apply an ON/OFF current to each base terminal so that each of the first/second bipolar transistors (1610, 1620) can operate as a switch. Alternatively, the controller may apply a current having a linear value to each base terminal so that each of the first/second bipolar transistors (1610, 1620) can linearly adjust a width of the current path.

Furthermore, a measurement resistor (not shown) may be arranged between a common connection node (C) of collectors of the first/second bipolar transistors (1610, 1620) and a common connection node (D) at cathode side of the first/second rectifying diodes (1370, 1380).

The DC-AC converter (110) may convert a DC voltage to an AC voltage by using four switching transistors to change the direction of DC current applied to a coil at an input side of the transformer unit (120).

Meanwhile, the controller controlling the first/second bipolar transistors (1610, 1620) may apply control signals (C1, C2) to the four switching transistors controlling the four switching transistors of the DC-AC converter (110). The controller may use the control signals (C1, C2) for feedback control of constant current flow by receiving a current flowing in the measurement resistor. Explanation of operation and principle of the illustrated LED driver can be easily derived from that of FIG. 14, such that no overlapping explanation will be provided.

An LED driver of FIG. 18 may further include first stabilizing resistors (1630) connected between a connection node between first LED strings (1330) and first ripple removing capacitor (1450) and first sub-rectifying diodes (1410), and second stabilizing resistors (1640) connected between a connection node between the second LED strings (1340) and the second ripple removing capacitor (1460) and the second sub-rectifying diodes (1420), the configuration of which differs that of the LED driver in FIG. 7. Remaining constituent elements of FIG. 18 except for the first/second stabilizing resistors (1630, 1640) are the same as those of FIG. 17, such that no redundant explanation will be given.

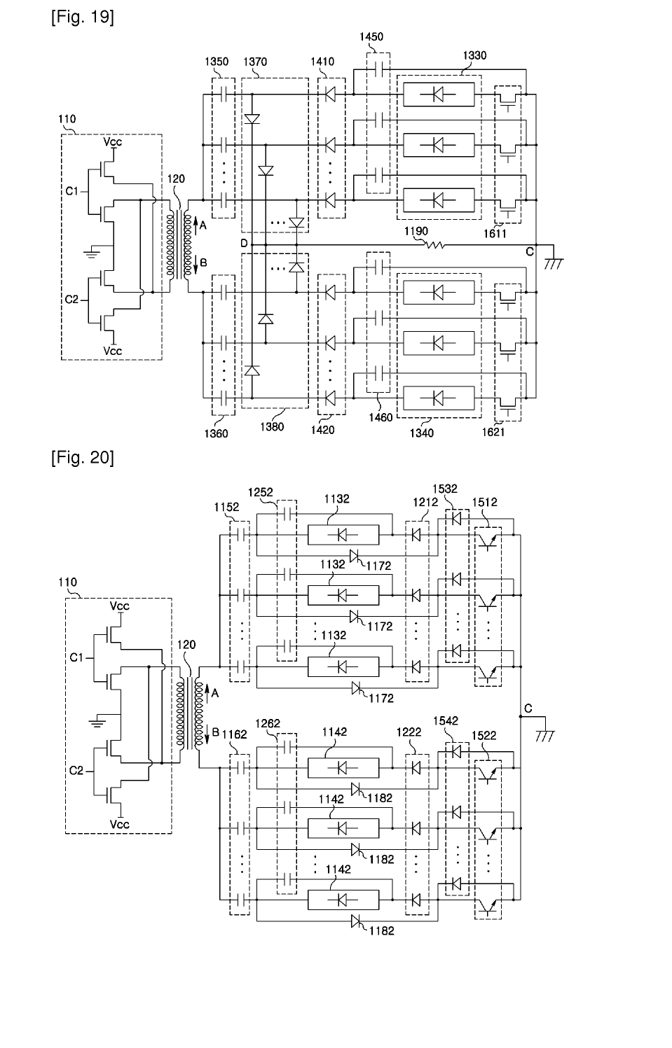

The LED driver of FIG. 19 employs first MOS transistors (1611) replacing the first bipolar transistors (1610) of FIG. 17, and second MOS transistors (1621) replacing the second bipolar transistors (1620). Furthermore, a measurement resistor (1190) not shown in FIG. 17 is used.

The MOS transistor is different from the bipolar transistor in that the MOS transistor cannot linearly control a current path but is capable of conducting an ON/OFF control. The MOS transistor is also different from the bipolar transistor in that the MOS transistor is controlled by voltage, not by current. However, the ON/OFF operation is the same for both transistors, each as a kind of switch, such that there will be no further redundant description thereto. Remaining constituent elements of FIG. 19 except for the first/second MOS transistors (1611, 1621) and the measurement resistor (1190) are the same as those of FIG. 17, such that no overlapping explanation will be provided.

FIG. 20 is a circuit diagram illustrating an LED driver smoothing a driving power of LED strings using a dividing AC driving method according to still another exemplary embodiment of the present invention.

A DC-AC converter (110) of FIG. 20 may be functionally a counterpart to the DC-AC converter (11) of FIG. 13, and first/second rectifying diodes (1172, 1182) and first/second sub-rectifying diodes (1212, 1222) {or first/second LED strings (1132, 1142)} of FIG. 20 may be functionally counterparts to the rectifier (107) of FIG. 13. First/second balancing capacitors (1152, 1162) of FIG. 20 may be functionally counterparts to the current balancing capacitor (105) of FIG. 13, while first/second LED strings (1132, 1142) of FIG. 20 may be counterparts to the LED strings (103) of FIG. 13. Bipolar transistors (1512) of FIG. 20 serves to function the path control element (108) of FIG. 13.

The LED driver of FIG. 20 may include a DC-AC converter (110) as an AC power supply applying an AC voltage to the LED driver, a transformer unit (120) receiving the AC voltage from the DC-AC converter (110) through an input port, at least one or more first LED strings (1142) receiving a first-direction (A) current from an output port of the transformer unit (120), at least one or more second LED strings (1132) receiving a second-direction (B) current from an output port of the transformer unit (120), at least one or more first balancing capacitors (1152) disposed between the output port of the transformer unit (120) and the second LED strings (1132), at least one or more second balancing capacitors (1162) disposed between the output port of the transformer unit (120) and the first LED strings (1142), at least one or more first rectifying diodes (1172) for forming a single direction rectifying current path via the first balancing capacitors (1152) to the first LED strings (1142), and at least one or more second rectifying diodes (1182) for forming a single direction rectifying current path via the second balancing capacitors (1162) to the second LED strings (1132), at least two first bipolar transistors (1512) adjusting a current path of the each first LED string (1142), and at least two second bipolar transistors (1522) adjusting a current path of the each second LED string (1132), first bypass diodes (1532) forming a bypass path when the first bipolar transistors (1512) are blocked, and second bypass diodes (1542) forming a bypass path when the second bipolar transistors (1522) are blocked.

The first/second rectifying diodes (1172, 1182) and the first/second LED strings (1132, 1142) may form a rectifying circuit due to intrinsic reverse direction current limiting function of the first/second LED strings (1132, 1142), which is caused by the fact that the first/second LED strings (1132, 1142) basically have characteristics as diodes.

However, in order to arrange first/second ripple removing capacitors (1252, 1262), or to prevent the LEDs from being damaged by an instant high voltage reverse current, at least one or more first sub-rectifying diodes (1222) connected in the same direction as that of the first LED strings (1142) between the second bipolar transistors (1522) and the first LED strings (1142) may be arranged, and at least one or more second rectifying diodes (1212) connected in the same direction as that of the second LED strings (1132) between the first bipolar transistors (1512) and the second LED strings (1132) may be arranged.

Still furthermore, in order to limit ripple components in the current introduced via the transformer unit (120) and the first/second balancing capacitors (1152,1162), at least one or more first ripple removing capacitors (1262) connected in parallel with the first LED strings (1142), and at least one or more second ripple removing capacitors (1252) connected in parallel with the second LED strings (1132) may be arranged.

Still furthermore, a current measuring device may be disposed at an output port of the transformer unit (120) or a common node of the first balancing capacitors. The current measuring device may be a current measuring transformer.

The DC-AC converter (110) may convert a DC voltage to an AC voltage by using four switching transistors to change the direction of DC current applied to a coil at an input side of the transformer unit (120).

An emitter terminal and a collector terminal of each first bipolar transistor (1512) and each second bipolar transistor (1522) are connected by a first bypass diode (1532) and a second bypass diode (1542). Each bipolar transistor and bypass diode pair function as a switch to a single direction. This is due to the fact that an individual control on a particular LED only in the A direction section can prevent the B direction section from being influenced.

Furthermore, although it is not shown in the figure, the LED driver may include a controller individually adjusting each base terminal current of the first/second bipolar transistors (1512, 1522). The controller may apply an ON/OFF current to each base terminal so that each of the first/second bipolar transistors (1512, 1522) can operate as a switch. Alternatively, the controller may apply a current having a linear value to each base terminal so that each of the first/second bipolar transistors (1512, 1522) can linearly adjust a width of the current path.

The controller may apply control signals (C1, C2) to the four switching transistors controlling the four switching transistors of the DC-AC converter (110). The controller may use the control signals (C1, C2) for feedback control of constant current flow by receiving a current flowing in the measurement resistor.

Now, operation of the illustrated LED driver will be described in detail.

An AC pattern (e.g., sine wave) current flows in a coil at the output terminal side of the transformer unit, and the AC current passes the first/second balancing capacitors (1542, 1162) to be applied to the first/second LED strings (1132, 1142).

In a case an A direction current flows in the output terminal side of the transformer according to a plus direction pattern in the sine wave, although the A direction current passes through the first LED strings (1142) and the first sub-rectifying diodes (1222) applied with a forward bias, the current cannot pass the second LED strings (1132) and the second sub-rectifying diodes (1212) where a reverse bias is applied.

The current for the first LED strings (1142) passes the first balancing capacitors (1152), the first rectifying diodes (1172) and the first bipolar transistors (1512) to flow to the C node, whereby the A direction current circulates through the current path.

Resultantly, the first LED strings (1142) are driven in a section where the current flows in the A direction, while the second LED strings (1132) are not driven. In the likewise process, the second LED strings (1132) are driven in a section where the current flows in the B direction, while the first LED strings (1142) are not driven.

That is, the first rectifying diodes (1172) and the first sub-rectifying diodes (1222) or the first LED strings (1142) form a kind of half-wave rectifying circuit. Furthermore, the second rectifying diodes (1182) and the second sub-rectifying diodes (1212) or the second LED strings (1132) form a kind of half-wave rectifying circuit. Although both cases form a half-wave rectifying circuit, the first LED strings (1142) are driven in a section where a current flows in the A direction, while the second LED strings (1132) are driven in a section where a current flows in the B direction, such that there is generated no power loss as experienced by the conventional half-wave rectifying circuit.

In the illustrated LED driver, in a case there exists a deviation in the forward direction voltage drop due to characteristic deviation of each first LED string (1142), each first/second balancing capacitor (1152, 1162) is only accumulated with mutually different charges by the deviation in the section where a current flow is in A direction. The charges of different quantity accumulated in the each first/second balancing capacitor (1152, 1162) are offset therebetween, or removed in the section where a current flows in the B direction. After all, even if there is a deviation in the forward voltage drop in each first LED string (1142), there is generated no current deviation (or brightness deviation resultant therefrom) in the first LED strings (1142) of the illustrated LED driver. In the likewise theory, even if there is a deviation in the forward voltage drop in each second LED string (1132), there is generated no current deviation (or brightness deviation resultant therefrom) in the second LED strings (1132).

Now, with regard to the A direction current path and the B direction current path, there are no resistance elements on the two current paths. Therefore, it is appreciated that the illustrated LED driver can greatly restrict the heating loss that is caused by the resistance elements.

Meanwhile, an appropriate adjustment of base current at the first bipolar transistors (1512) or the second bipolar transistors (1522) can individually adjust the brightness of the first LED strings (1142) or the second LED strings (1132). For example, an current turning on and turning off the first/second bipolar transistors (1512, 1522) may be applied to the base to individually adjust the brightness by way of PWM (Pulse Width Modulation) method.

An LED driver of FIG. 21 may further include first stabilizing resistors (1562) connected between connection nodes of first LED strings (1142), a first ripple removing capacitor (1262) and first sub-rectifying diodes (1222), and second stabilizing resistors (1552) connected between connection nodes of second LED strings (1132), a second ripple removing capacitor (1252) and second sub-rectifying diodes (1212), the configuration of which differs that of the LED driver in FIG. 20.

Switching by using the first bipolar transistors (1512) and the second bipolar transistors (1522) whose emitter terminals are grounded may decrease the grounding characteristic, where the first/second stabilizing resistors (1562, 1552) may prevent the grounding characteristic from being deteriorated. Other constituent elements in FIG. 21 are the same as those of FIG. 20 except for the first/second stabilizing resistors (1562, 1552), such that overlapping explanation is omitted.

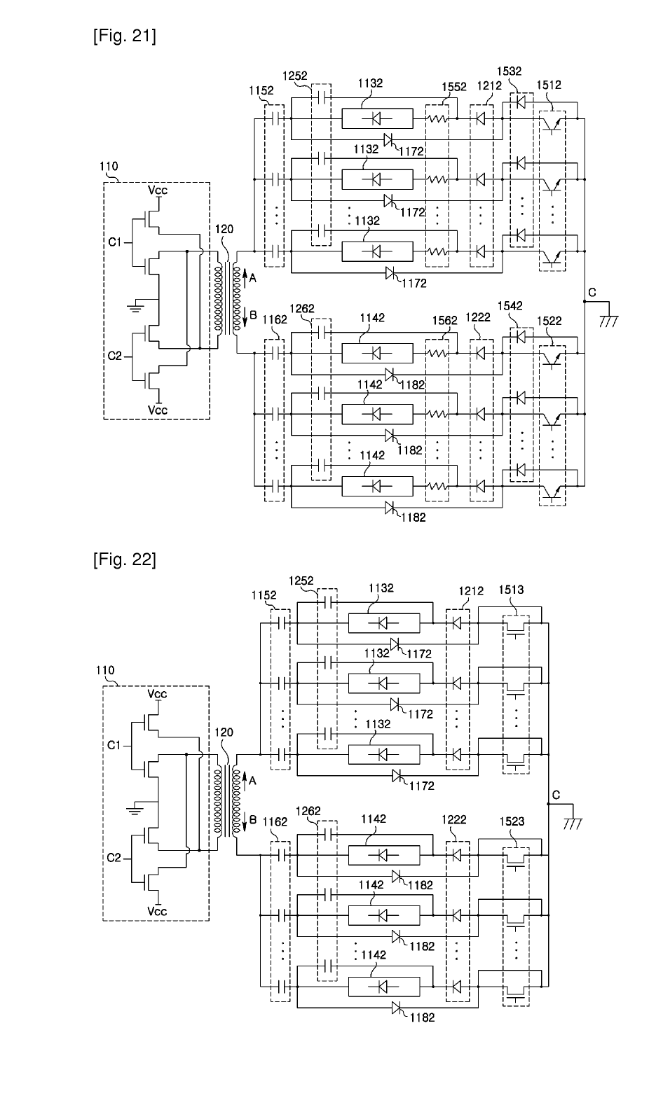

The LED driver of FIG. 22 employs first MOS transistors (1513) replacing the first bipolar transistors (1512) of FIG. 20, and second MOS transistors (1523) replacing the second bipolar transistors (1522) of FIG. 20. The conventional MOS transistor switches are formed with substrate diodes, such that the first bypass diode (1532) and the second bypass diode (1542) of FIG. 20 are removed. However, in a case the LED driver is implemented using other types of transistors such as FETs (Field Effect Transistors) than the MOS transistors, the first bypass diode (1532) and the second bypass diode (1542) may be employed.

The MOS transistor is different from the bipolar transistor in that the MOS transistor cannot linearly control a current path but is capable of conducting an ON/OFF control. The MOS transistor is also different from the bipolar transistor in that the MOS transistor is controlled by voltage, not by current. However, the ON/OFF operation is the same for both transistors, each as a kind of switch, such that there will be no further redundant description thereto. Remaining constituent elements of FIG. 22 except for the first/second MOS transistors (1513, 1523) are the same as those of FIG. 20, such that no redundant explanation will be provided.

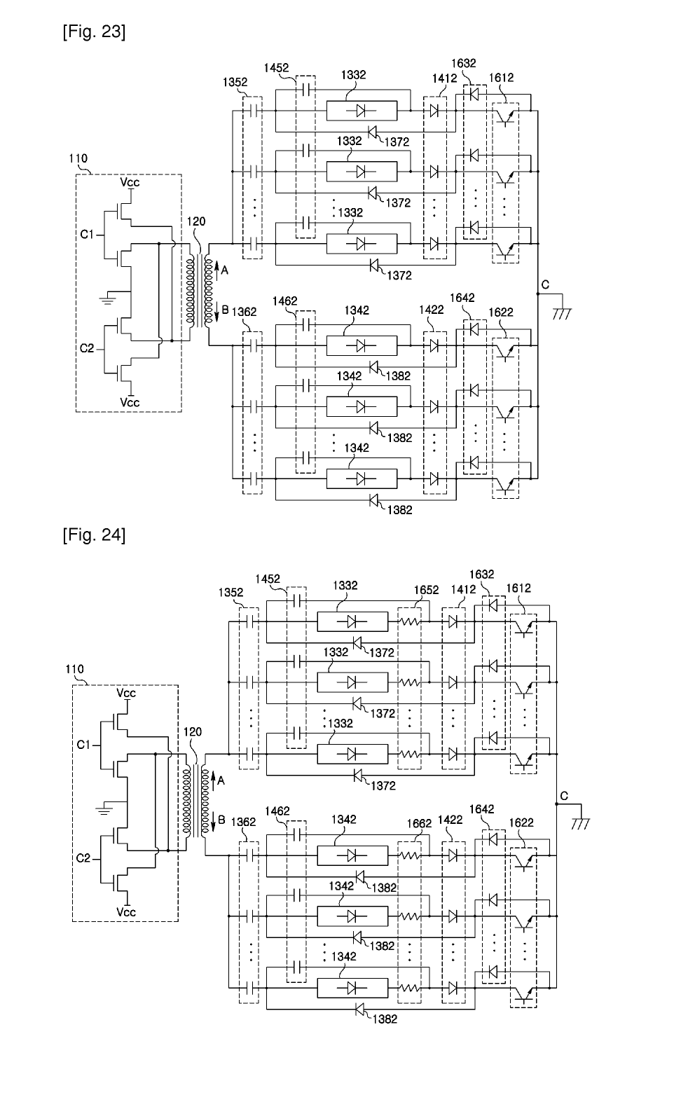

FIG. 23 is a circuit diagram illustrating an LED driver smoothing a driving power of LED strings using a dividing AC driving method according to still another exemplary embodiment of the present invention.

The LED driver of FIG. 23 may include a DC-AC converter (110) as an AC power supply applying an AC voltage to the LED driver, a transformer unit (120) receiving the AC voltage from the DC-AC converter (110) through an input port, at least one or more first LED strings (1332) receiving a first-direction (A) current from an output port of the transformer unit (120), at least one or more second LED strings (1342) receiving a second-direction (B) current from an output port of the transformer unit (120), at least one or more first balancing capacitors (1352) disposed between the output port of the transformer unit (120) and the first LED strings (1332), at least one or more second balancing capacitors (1362) disposed between the output port of the transformer unit (120) and the second LED strings (1342), at least one or more first rectifying diodes (1382) for forming a single direction rectifying current path via the first balancing capacitor (1352) to the first LED strings (1332), and at least one or more second rectifying diodes (1372) for forming a single direction rectifying current path via the second balancing capacitor (1362) to the second LED strings (1342), at least two first bipolar transistors (1612) adjusting a current path of the each first LED string (1332), and at least two second bipolar transistors (1622) adjusting a current path of the each second LED string (1342), first bypass diodes (1632) forming a bypass path when the first bipolar transistors (1612) are blocked, and second bypass diodes (1642) forming a bypass path when the second bipolar transistors (1622) are blocked.

The first/second rectifying diodes (1372, 1382) and the first/second LED strings (1332, 1342) may form a rectifying circuit due to intrinsic reverse direction current limiting function of the first/second LED strings (1332, 1342), which is caused by the fact that the first/second LED strings (1332, 1342) basically have characteristics as diodes.

However, in order to arrange first/second ripple removing capacitors (1452, 1462), or to prevent the LEDs from being damaged by an instant high voltage reverse current, at least one or more first sub-rectifying diodes (1412) connected in the same direction as that of the first LED strings (1332) between the first bipolar transistor (1612) and the first LED strings (1332) may be arranged, and at least one or more second rectifying diodes (1422) connected in the same direction as that of the second LED strings (1342) between the second bipolar transistors (1622) and the second LED strings (1342) may be arranged.

In order to limit ripple components in the current introduced via the transformer unit (120) and the first/second balancing capacitors (1352,1362), at least one or more first ripple removing capacitors (1452) connected in parallel with the first LED strings (1332), and at least one or more second ripple removing capacitors (1462) connected in parallel with the second LED strings (1342) may be arranged.

Furthermore, a current measuring device may be disposed at an output port of the transformer unit (120). The current measuring device may be a current measuring transformer.

The DC-AC converter (110) may convert a DC voltage to an AC voltage by using four switching transistors to change the direction of DC current applied to a coil at an input side of the transformer unit (120).

An emitter terminal and a collector terminal of each first bipolar transistor (1612) and each second bipolar transistor (1622) are connected by a first bypass diode (1632) and a second bypass diode (1642). Each bipolar transistor and bypass diode pair function as a switch to a single direction. This is due to the fact that an individual control on a particular LED only in the A direction section can prevent the B direction section from being influenced.

Furthermore, although it is not shown in the figure, the LED driver may include a controller individually adjusting each base terminal current of the first/second bipolar transistors (1612, 1622). The controller may apply an ON/OFF current to each base terminal so that each of the first/second bipolar transistors (1612, 1622) can operate as a switch. Alternatively, the controller may apply a current having a linear value to each base terminal so that each of the first/second bipolar transistors (1612, 1622) can linearly adjust a width of the current path.

The controller may apply control signals (C1, C2) to the four switching transistors controlling the four switching transistors of the DC-AC converter (110). The controller may use the control signals (C1, C2) for feedback control of constant current flow by receiving a current flowing in the measurement resistor.

The description of operation and principle of the illustrated LED driver can be easily derived from the explanation of FIG. 20, such that any redundant description will be omitted.

An LED driver of FIG. 24 may further include first stabilizing resistors (1652) connected between connection nodes of first LED strings (1332), a first ripple removing capacitor (1452) and first sub-rectifying diodes (1412), and second stabilizing resistors (1662) connected between connection nodes of second LED strings (1342), a second ripple removing capacitor (1462) and second sub-rectifying diodes (1422), the configuration of which differs that of the LED driver in FIG. 23.

Switching by using the first bipolar transistors (1612) and the second bipolar transistors (1622) whose emitter terminals are grounded may decrease the grounding characteristic, where the first/second stabilizing resistors (1652, 1662) may prevent the grounding characteristic from being deteriorated. Other constituent elements in FIG. 24 are the same as those of FIG. 23 except for the first/second stabilizing resistors (1652, 1662), such that overlapping explanation is omitted.

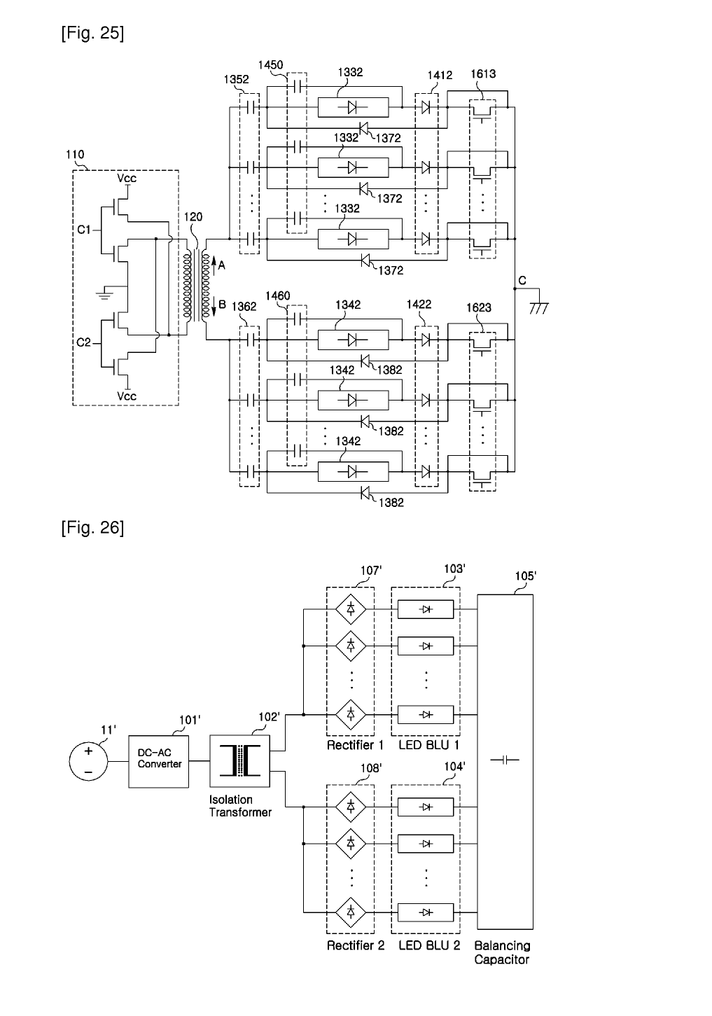

A LED driver of FIG. 25 employs first MOS transistors (1613) replacing the first bipolar transistors (1612) of FIG. 23, and second MOS transistors (1623) replacing the second bipolar transistors (1622) of FIG. 23. Other constituent elements in FIG. 25 are the same as those of FIG. 22 except for directions of the first/second MOS transistors (1613, 1623), such that overlapping explanation is omitted.

### Third Exemplary Embodiment

FIG. 26 is a block diagram illustrating a concept of an LED driver according to still another exemplary embodiment of the present invention.

An illustrated LED driver may include first LED strings (103′), second LED strings (104′), a first rectifier (107′) rectifying a first direction AC voltage current and supplying the rectified current to the first LED strings (103′), a second rectifier (108′) rectifying a second direction AC voltage current and supplying the rectified current to the second LED strings (104′), and a balancing unit (105′) positioned between the first/second LED strings (103′, 104′) for current balancing of the first/second LED strings (103′, 104′), and may further include at a power supply side a DC-AC converter (101′) for converting the DC voltage to AC voltage along with a DC power supply (11′), and a transformer unit (102′) for transmitting the converted AC voltage to the LED strings (103′).

The illustrated LED driver alternatively drives the first LED strings (103′) and the second LED strings (104′) in response to the AC current direction, and the currents introduced into each LED string by the balancing unit (105′) disposed between the first LED strings (103′) and the second LED strings (104′) can be uniformly adjusted. The balancing unit (105′) has a capacitor characteristic for an inexpensive and efficient current balancing.

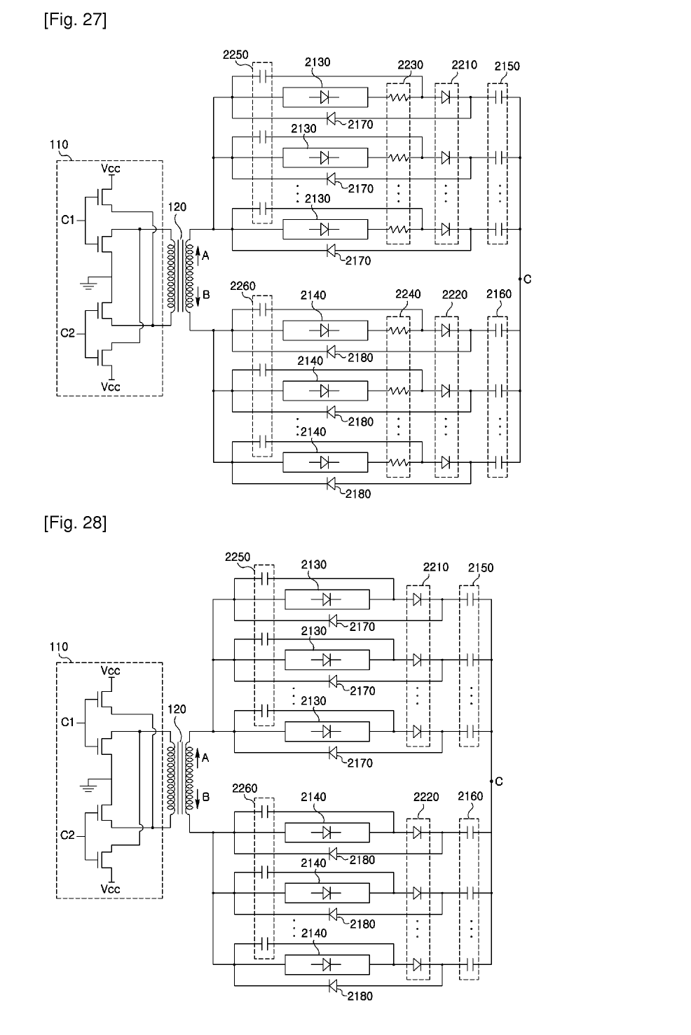

FIG. 27 is a circuit diagram illustrating an LED driver smoothing a driving power of LED strings using a dividing AC driving method according to still another exemplary embodiment of the present invention.

The DC-AC converter (110) of FIG. 27 serves the function of the DC-AC converter (11′) of FIG. 16, a first rectifying diode (2170) and a sub-rectifying diode (2210) or first LED strings (2130) serve the function of the first rectifier (107′) of FIG. 26, and a second rectifying diode (2180), a second sub-rectifying diode (2220) or second strings (2140) of FIG. 27 serve the function of the second rectifier (108′) of FIG. 26. First/second balancing capacitors (2150, 2160) perform the role of the balancing unit (105′) of FIG. 26.

The LED driver of FIG. 27 may include a DC-AC converter (110) as an AC power supply applying an AC voltage to the LED driver, a transformer unit (120) receiving the AC voltage from the DC-AC converter (110) through an input port, at least one or more first LED strings (2130) receiving a first-direction (A) current from an output port of the transformer unit (120), at least one or more second LED strings (2140) receiving a second-direction (B) current from an output port of the transformer unit (120), at least one or more first balancing capacitors (2150) connected to a common node (C) at some ends for forming a current path to each LED string, at least one or more second balancing capacitors (2160) connected to the common node (C) at some ends for forming a current path to each second LED string, at least one or more first rectifying diodes (2170) for forming a single direction rectifying current path via the first balancing capacitor (2150) to the second LED strings (2140), and at least one or more second rectifying diodes (2180) for forming a single direction rectifying current path via the second balancing capacitor (2160) to the first LED strings (2130).

Now, the first LED strings (2130) are so disposed as to allow the current to flow from the first LED strings (1230) to the first balancing capacitors (2140), and the second LED strings (2140) are so disposed as to allow the current to flow from the second LED strings (2140) to the second balancing capacitors (2160).

The first/second rectifying diodes (2130, 2140) and the first/second LED strings (2130, 2140) may form a rectifying circuit due to intrinsic reverse direction current limiting function of the first/second LED strings (2130, 2140), which is caused by the fact that the first/second LED strings 2130, 2140) basically have characteristics as diodes.

However, in order to arrange first/second ripple removing capacitors (2250, 2260), or to prevent the LEDs from being damaged by an instant reverse high voltage current, at least one or more first sub-rectifying diodes (2210) connected in the same direction as that of the first LED strings (2130) between the first balancing capacitors (2150) and the first LED strings (2130) may be arranged, and at least one or more second sub-rectifying diodes (2220) connected in the same direction as that of the second LED strings (2140) between the second balancing capacitors (2160) and the second LED strings (2140) may be arranged.

Furthermore, in order to protect the first/second LED strings (2130, 2140), at least one or more first resistors (2230) connected between the first sub-rectifying diodes (2210) and the first LED strings (2130), and at least one or more second resistors (2240) connected between the second sub-rectifying diodes (2220) and the second LED strings (2140) may be additionally arranged.

In order to bypass ripple components in the current introduced via the transformer unit (120) and the first/second balancing capacitors (2150, 2160), at least one or more first ripple removing capacitors (2250) connected in parallel with the first LED strings (2130), and at least one or more second ripple removing capacitors (2260) connected in parallel with the second LED strings (2140) may be arranged.

Still furthermore, a current measuring device may be disposed at an output port of the transformer unit. The current measuring device may be a current measuring transformer.

The DC-AC converter (110) may convert a DC voltage to an AC voltage by using four switching transistors to change the direction of DC current applied to a coil at an input side of the transformer unit (120).

Although it is not shown in the figure, the LED driver may include a controller generating control signals (C1, C2) for controlling four switching transistors of the DC-AC converter (110). The controller may use the control signals (C1, C2) by receiving a current measured by the current measuring device to perform a feedback control so that the current flows constantly.

Now, operation of the illustrated LED driver will be described in detail.

An AC pattern (e.g., sine wave) current flows in a coil at the output terminal side of the transformer unit, and the AC current is applied to the first/second LED strings (2130, 2140).

In a case an A direction current flows in the output terminal side of the transformer according to a plus direction pattern in the sine wave, although the A direction current passes through the first LED strings (2130) and the first sub-rectifying diodes (2210) applied with a forward bias, the current cannot pass the second LED strings (2140) and the second sub-rectifying diodes (2220) where a reverse bias is applied.

The current having passed the first LED strings (2130) and the first sub-rectifying diode (2210) collects a C node via the first balancing capacitor (2150). The current collected at C node passes the second balancing capacitor (2160) and the second diodes (2180) where a forward bias is applied, and is fedback to the transformer unit (110).

Resultantly, the first LED strings (1230) are driven in a section where the current flows in the A direction, while the second LED strings (2140) are not driven. In the likewise process, the second LED strings (2140) are driven in a section where the current flows in the B direction, while the first LED strings (2130) are not driven.

That is, the first rectifying diodes (2170) and the first sub-rectifying diodes (2210 or the first LED strings (2130) form a kind of half-wave rectifying circuit. Furthermore, the second rectifying diodes (2180) and the second sub-rectifying diodes (2220) or the second LED strings (2140) form a kind of half-wave rectifying circuit. Although both cases form a half-wave rectifying circuit, the first LED strings (2130) are driven in a section where a current flows in the A direction, while the second LED strings (2140) are driven in a section where a current flows in the B direction, such that there is generated no power loss as experienced by the conventional half-wave rectifying circuit.

In the illustrated LED driver, in a case there exists a deviation in the forward direction voltage drop due to characteristic deviation of each first LED string (2130), each first/second balancing capacitor (2150, 2160) is only accumulated with mutually different charges by the deviation in the section where a current flow is in A direction. The charges of different quantity accumulated in the each first/second balancing capacitor (2150, 2160) are offset therebetween, or removed in the section where a current flows in the B direction. After all, even if there is a deviation in the forward voltage drop in each first LED string (2130), there is generated no current deviation (or brightness deviation resultant therefrom) in the first LED strings (1230) of the illustrated LED driver. In the likewise theory, even if there is a deviation in the forward voltage drop in each second LED string (2140), there is generated no current deviation (or brightness deviation resultant therefrom) in the second LED strings (2140).

Now, with regard to the A direction current path and the B direction current path, there are no resistance elements on the two current paths except for a first resistor (2230) and a second resistor (2240). Therefore, it is appreciated that the illustrated LED driver can greatly restrict the heating loss that is caused by the resistance elements.

FIG. 28 is a circuit diagram illustrating an LED driver having a simpler structure than that of FIG. 27 according to still another exemplary embodiment of the present invention, where there is no resistance on the driving path. Explanation of operation and principle of the illustrated LED driver can be easily derived from that of FIG. 27, such that no overlapping explanation will be provided.

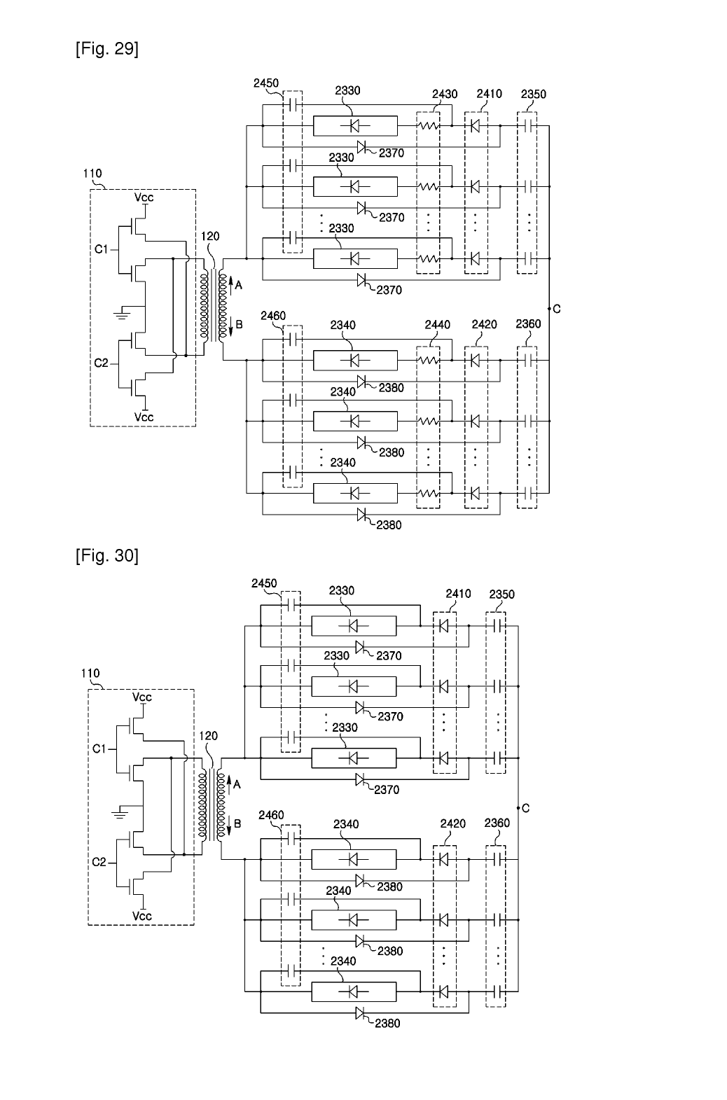

FIG. 29 is a circuit diagram illustrating an LED driver smoothing a driving power of LED strings using a dividing AC driving method according to still another exemplary embodiment of the present invention.

An LED driver according FIG. 29 may include a DC-AC converter (110) as an AC power supply applying an AC voltage to the LED driver, a transformer unit (120) receiving the AC voltage from the DC-AC converter (110) through an input port, at least one or more first LED strings (2330) receiving a first-direction (A) current from an output port of the transformer unit (120), at least one or more second LED strings (2340) receiving a second-direction (B) current from an output port of the transformer unit (120), at least one or more first balancing capacitors (2350) connected to a common node (C) at some ends for forming a current path to each LED string, at least one or more second balancing capacitors (2360) connected to the common node (C) at some ends for forming a current path to each second LED string, at least one or more first rectifying diodes (2370) for forming a single direction rectifying current path via the first balancing capacitor (2350) to the second LED strings (2340), and at least one or more second rectifying diodes (2380) for forming a single direction rectifying current path via the second balancing capacitor (2360) to the first LED strings (2330).

At this time, the first LED strings (2330) are so disposed as to allow the current to flow to the first LED strings (2330) from the first balancing capacitors (2350), and the second LED strings (2340) are so disposed as to allow the current to flow to the second LED strings (2340) to the second balancing capacitors (2360).

The first/second rectifying diodes (2270, 2380) and the first/second LED strings (2330, 2340) may form a rectifying circuit due to intrinsic reverse current limiting function of the first/second LED strings (2330, 2340), which is caused by the fact that the first/second LED strings (2330, 2340) basically have characteristics as diodes.

However, in order to arrange first/second ripple removing capacitors (2450, 2460), or to prevent the LEDs from being damaged by an instant reverse high voltage current, at least one or more first sub-rectifying diodes (2410) connected in the same direction as that of the first LED strings (2330) between the first balancing capacitors (2350) and the first LED strings (2330) may be arranged, and at least one or more second sub-rectifying diodes (2420) connected in the same direction as that of the second LED strings (2340) between the second balancing capacitors (2360) and the second LED strings (2340) may be arranged.

Furthermore, in order to protect the first/second LED strings (2330, 2340), at least one or more first resistors (2430) connected between the first sub-rectifying diodes (2410) and the first LED strings (2330), and at least one or more second resistors (2440) connected between the second sub-rectifying diodes (2420) and the second LED strings (2340) may be additionally arranged.

In order to bypass ripple components in the current introduced via the transformer unit (120), at least one or more first ripple removing capacitors (2450) connected in parallel with the first LED strings (2330), and at least one or more second ripple removing capacitors (2460) connected in parallel with the second LED strings (2340) may be arranged.

Still furthermore, a current measuring device may be disposed at an output port of the transformer unit or at the common node (C) of the first balancing capacitor (2350). The current measuring device may be a current measuring transformer.

Meanwhile,although it is not shown in the figure, the LED driver may include a controller generating control signals (C1, C2) for controlling four switching transistors of the DC-AC converter (110). The controller may use the control signals (C1, C2) by receiving a current measured by the current measuring device to perform a feedback control so that the current flows constantly. Explanation of operation and principle of the illustrated LED driver can be easily derived from that of FIG. 4, such that no overlapping explanation will be provided.

FIG. 30 is a circuit diagram illustrating an LED driver having a simpler configuration than that of FIG. 29 and having no resistance on a driving path. Explanation of operation and principle of the illustrated LED driver can be easily derived from that of FIG. 5, such that no overlapping explanation will be provided.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

For example, although the present invention has exemplified an LED driver having first/second LED strings each having three LED strings, the present invention may be easily applied by an LED driver having two or more than four strings, which also belongs to the scope of the present invention.

### INDUSTRIAL APPLICABILITY

The LED driver according to the present invention thus configured may be applicable to industries in that it can restrict a heating loss and individually control the LED strings. Another advantage is that the LED driver can restrict a driving power loss. Still another advantage is that the LED driver can reduce the manufacturing cost. Still further advantage is that the LED driver can provide a current balancing between LED strings by way of a simple structure.

1. An LED driver, comprising:
at least two LED strings;
a rectifier rectifying an alternating current (AC) voltage for supply to the LED strings; and
at least two balancing capacitors positioned at a current path of each LED string for carrying out a current balancing of the LED strings.

2. The LED driver of claim 1, further comprising at least two path control elements for controlling the current path of each LED string; and
a controller controlling the path control elements.

3. The LED driver of claim 2, wherein the path control elements are switching elements blocking current paths of the LED strings.

4. The LED driver of claim 1, wherein the at least two or more LED strings include first LED strings and second LED strings, and wherein the rectifier includes a first rectifier rectifying a first direction current of AC voltage and supplying the current to the first LED strings, and a second rectifier rectifying a second direction current of AC voltage and supplying the current to the second LED strings, and wherein the current balancing capacitors are interposed between the first LED strings and the second LED strings for current-balancing of the first and second LED strings.

5. The LED driver of claim 1, comprising: a DC-AC converter for converting a DC current voltage to an AC current voltage, and a transformer unit for transmitting the converted AC voltage to the rectifier.

6. An LED driver, comprising:
a transformer unit receiving an AC voltage through an input port; at least one or more first LED strings receiving a first-direction current from an output port of the transformer unit;
at least one or more second LED strings receiving a second-direction current from an output port of the transformer unit;
at least one or more first balancing capacitors disposed between the output port of the transformer unit and the first LED strings;
at least one or more second balancing capacitors disposed between the output port of the transformer unit and the second LED strings;
at least one or more first rectifying diodes for forming a single direction current path for rectification of the second LED strings and the first balancing capacitors;
at least one or more second rectifying diodes for forming a single direction current path for rectification of the first LED strings and the second balancing capacitors;
first path control elements for controlling a current path of each first LED string; and
second path control elements for controlling a current path of each second LED string.

7. The LED driver of claim 6, further comprising:
at least one or more first sub-rectifying diodes connected in the same direction as that of the first LED strings between the first balancing capacitors and the first LED strings, and at least one or more second sub-rectifying diodes connected in the same direction as that of the second LED strings between the second balancing capacitors and the second LED strings.

8. The LED driver of claim 7, comprising: at least one or more first resistors connected between the first sub-rectifying diodes and the first LED strings, and at least one or more second resistors connected between the second sub-rectifying diodes and the second LED strings.

9. The LED driver of claim 6, comprising: at least one or more first ripple removing capacitors connected in parallel to the first LED strings, and at least one or more second ripple removing capacitors connected in parallel to the second LED strings.

10. The LED driver of claim 6, characterized in that the first LED strings are so arranged as to allow the current to flow in a direction from the first balancing capacitors to the first LED strings, the second LED strings are so arranged as to allow the current to flow in a direction from the second balancing capacitors to the second LED strings, cathodes of the first rectifying diodes are connected to each first balancing capacitor where anodes are commonly connected, and cathodes of the second rectifying diodes are connected to each second balancing capacitor where anodes are commonly connected to the first rectifying diodes.

11. The LED driver of claim 6, characterized in that the first LED strings are so arranged as to allow the current to flow in a direction from the first LED strings to the first balancing capacitors, the second LED strings are so arranged as to allow the current to flow in a direction from the second LED strings to the second balancing capacitors, anodes of the first rectifying diodes are connected to each first balancing capacitor where cathodes are commonly connected, and anodes of the second rectifying diodes are connected to each second balancing capacitor where cathodes are commonly connected to the first rectifying diodes.

12. The LED driver of claim 6, comprising: a DC-AC converter converting an externally supplied DC voltage to an AC voltage; a measuring resistor connected between the first LED strings and the second rectifying diodes; and a controller controlling an operation of the DC-AC converter in response to a current flowing in the measuring resistor.

13. The LED driver of claim 6, comprising: first path control elements controlling a current path of each first LED string; and second path control elements controlling a current path of each second LED string.

14. The LED driver of claim 13, comprising: the path control elements are switching elements blocking a current path of relevant LED string in response to a control signal.

15. The LED driver of claim 14, characterized in that the switching elements are MOS transistors or bipolar transistors.

16. The LED driver of claim 13, characterized in that the path control elements are transistors adjusting a width of the current path of relevant LED string in response to a control signal applied to a base terminal.

17. The LED driver of claim 13, characterized in that the first path control elements are commonly connected at ends, and the commonly connected node is grounded.

18. An LED driver, comprising:
a transformer unit receiving an AC voltage through an input port; at least one or more first LED strings receiving a first-direction current from an output port of the transformer unit;
at least one or more second LED strings receiving a second-direction current from an output port of the transformer unit;
at least one or more first balancing capacitors commonly connected at ends and forming a current path to each first LED string;
at least one or more second balancing capacitors commonly connected at ends to a common node of the first balancing capacitor and forming a current path to each second LED string;
at least one or more first rectifying diodes for forming a single direction current path via the first balancing capacitor to the second strings; and
at least one or more second rectifying diodes for forming a single direction current path via the second balancing capacitor to the first strings.

19. The LED driver of claim 18, further comprising: at least one or more first sub-rectifying diodes connected in the same direction as that of the first LED strings between the first balancing capacitors and the first LED strings; and at least one or more second sub-rectifying diodes connected in the same direction as that of the second LED strings between the second balancing capacitors and the second LED strings.

20. The LED driver of claim 19, further comprising: at least one or more first resistors connected between the first sub-rectifying diodes and the first LED strings, and at least one or more second resistors connected between the second sub-rectifying diodes and the second LED strings.

21. The LED driver of claim 18, further comprising: at least one or more first ripple removing capacitors connected in parallel to the first LED strings, and at least one or more second ripple removing capacitors connected in parallel to the second LED strings.

22. The LED driver of claim 18, characterized in that the first LED strings are so arranged as to allow the current to flow in a direction from the first balancing capacitors to the first LED strings, and the second LED strings are so arranged as to allow the current to flow in a direction from the second balancing capacitors to the second LED strings.

23. The LED driver of claim 18, characterized in that the first LED strings are so arranged as to allow the current to flow in a direction from the first LED strings to the first balancing capacitors, and the second LED strings are so arranged as to allow the current to flow in a direction from the second LED strings to the second balancing capacitors.

24. The LED driver of claim 18, comprising a DC-AC converter converting an externally supplied DC voltage to an AC voltage.

25. The LED driver of claim 24, comprising a current measuring device at the output port of the transformer unit or a common node of the first balancing capacitor.

26. The LED driver of claim 25, comprising a controller controlling an operation of the DC-AC converter in response to the measured current by the current measuring device.
